(19) United States
(12) Patent Application Publication
(10) Pub. No.: US 2026/0288328 A1
(43) Pub. Date: Sep. 24, 2026

(54) INPUT DEVICE, CONTROL METHOD FOR INPUT DEVICE, ARTICLE MANUFACTURING METHOD, AND RECORDING MEDIUM

(71) Applicant: CANON KABUSHIKI KAISHA, Tokyo (JP)

(72) Inventor: YUSAKU HINE, Tokyo (JP)

(21) Appl. No.: 19/561,798

(22) Filed: Mar. 10, 2026

(30) Foreign Application Priority Data
Mar. 18, 2025 (JP) 2025-044031

(51) Int. Cl. G06F 3/04886; G06F 3/04845

(52) U.S. Cl. CPC G06F 3/04886; G06F 3/04845; G06F 2203/04808

(57) ABSTRACT

An input device includes a display screen, and a touch input detection unit. The touch input detection unit is configured to detect a touch input operation on the display screen. In a device operation mode in which a device is operable by a user performing the touch input operation on the display screen, a first image and a second image are displayed on the display screen, the first image receiving an operation command for the device by the touch input operation, the second image permitting transmission of the operation command by receiving the touch input operation in a state in which the touch input operation on the first image is performed. A display state of the second image is changeable in the device operation mode.

### BACKGROUND

### Field of the Technology

The present disclosure relates to an input device used when a user operates a device, and the like.

### Description of the Related Art

Hitherto, as an input device used when a user operates a device, a control panel including a switch having a mechanical mechanism (hereinafter, referred to as a hardware switch) is generally used. As the hardware switch attached to the control panel, a switch having a three-position mechanism (hereinafter, referred to as an enable switch) is generally used.

The enable switch is a switch that enables input when operated with an appropriate force, and serves as a safety function for preventing uncontrolled operation of the device caused by an erroneous instruction input to the control panel due to an erroneous user operation, loss of consciousness, or the like. In order to improve operability, the enable switch is often installed on a grip portion of a portable control panel. By doing so, the enable switch can be operated with a hand holding the control panel, so that the user can operate the enable switch and perform other operations at the same time.

Meanwhile, recently, an input device including, instead of a mechanical switch, a software switch configured to receive input when a display screen is touched has been known. For example, an operation panel (hereinafter, referred to as a touch panel) in which an image (software switch) of a graphical switch is displayed on a display screen such as a liquid crystal display, and which can receive operation or input via a finger, a stylus, or the like, has been used.

In addition, it has also been attempted that a general-purpose terminal that can function as a touch panel, such as a smartphone or a tablet PC, is connected to a device by wireless communication or wired communication to enable the user to operate the device. In a case where the user operates the device by using the touch panel, unlike the mechanical enable switch having a three-position mechanism, there is a high possibility that an erroneous instruction is input due to erroneous user operation, loss of consciousness, or the like, and the device operates in an uncontrolled manner.

Therefore, WO 2019/150473 A proposes a control method for preventing erroneous operation and uncontrolled operation of a device even in a case where the device is operated using only a software switch displayed on a touch panel. A touch panel device of WO 2019/150473 A includes a touch panel in which a capacitance of a contact region changes by a touch operation, a pressure sensor unit that outputs a pressure detection signal according to a pressing force applied to an operation surface, and a control unit that calculates coordinates indicating a position of the touch operation on the operation surface.

According to WO 2019/150473 A, the touch operation includes a first touch operation on the operation surface and a second touch operation on the operation surface. In a case where the first touch operation is performed and a first condition that a pressing value is within a predetermined reference pressure range is satisfied, the control unit determines that touch operation information input by the second touch operation is valid. On the other hand, in a case where the first condition is not satisfied, the control unit determines that the touch operation information input by the second touch operation is invalid.

The method described in WO 2019/150473 A is expected to be able to prevent, to some extent, uncontrolled operation of a device caused by an erroneous instruction input due to erroneous user operation, loss of consciousness, or the like in a case where the device is operated using a software switch displayed on a touch panel. However, in the method described in WO 2019/150473 A, it is necessary to use the touch panel including the pressure sensor unit that outputs the pressure detection signal according to the pressing force applied to the operation surface, and the method cannot be executed with a touch panel that merely detects a touch position. In addition, an operator needs to accurately perform the first touch operation and the second touch operation with one hand in a state of holding the touch panel with the other hand. In this case, it cannot be said that a software switch that enables easy input for the operator is configured on the touch panel, and it was difficult to safely and efficiently operate the device.

### SUMMARY

One of the problems to be solved by the embodiments disclosed in the present specification and the drawings is to provide a technology that enables an operator to safely and efficiently operate a device. However, the problems to be solved by the embodiments disclosed in the present specification and the drawings are not limited to the above problem. A problem corresponding to each effect achieved by each configuration described in the embodiments described below can also be regarded as another problem.

According to a first aspect of the present disclosure, an input device includes a display screen, and a touch input detection unit configured to detect a touch input operation on the display screen. In a device operation mode in which a device is operable by a user performing the touch input operation on the display screen, a first image and a second image are displayed on the display screen, the first image receiving an operation command for the device by the touch input operation, the second image permitting transmission of the operation command by receiving the touch input operation in a state in which the touch input operation on the first image is performed. A display state of the second image is changeable in the device operation mode.

According to a second aspect of the present disclosure, a control method for an input device including a display screen, and a touch input detection unit configured to detect a touch input operation on the display screen includes displaying, in a device operation mode in which a device is operable by a user performing the touch input operation on the display screen, a first image and a second image on the display screen, the first image receiving an operation command for the device by the touch input operation, the second image permitting transmission of the operation command by receiving the touch input operation, and causing a display state of the second image to be changeable in the device operation mode.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic diagram illustrating an entire production system according to an embodiment.

FIG. 2 is a block diagram illustrating a configuration of an input device according to the embodiment.

FIG. 3 is a view illustrating an image displayed on a touch panel in an editing stage.

FIG. 4 is a view for describing editing work in the editing stage.

FIG. 5 is a view illustrating a control panel image displayed on the touch panel in a device operation stage (device operation mode).

FIG. 6 is a flowchart illustrating an operation of main processing.

FIG. 7 is a flowchart illustrating a processing procedure of input processing S20 in detail.

FIG. 8 is a flowchart illustrating a processing procedure of display control processing S30 in detail.

FIG. 9 is a flowchart illustrating a processing procedure of output control processing S60.

FIG. 10 is a diagram illustrating an example of a configuration of the control panel image displayed on the touch panel in the device operation stage (device operation mode).

FIG. 11A is a diagram illustrating an example in which a display state of a device operation permission region is changed when an operator performs a predetermined gesture by touch input using a contacting body.

FIG. 11B is a diagram illustrating the example in which the display state of the device operation permission region is changed when the operator performs a predetermined gesture by touch input using the contacting body.

FIG. 12 is a diagram illustrating an example of a method of easily designating an arbitrary position as a movement destination of the device operation permission region (second image).

FIG. 13A is a diagram illustrating an example of a method of moving the device operation permission region (second image) so as to follow a touch operation on a device operation input region (first image).

FIG. 13B is a diagram illustrating the example of the method of moving the device operation permission region (second image) so as to follow the touch operation on the device operation input region (first image).

FIG. 14A is a diagram illustrating a method of switching between non-display and display of the device operation permission region (second image).

FIG. 14B is a diagram illustrating the method of switching between non-display and display of the device operation permission region (second image).

FIG. 14C is a diagram illustrating the method of switching between non-display and display of the device operation permission region (second image).

FIG. 15A is a diagram illustrating a method of rearranging a component of the device operation input region (first image) and displaying the rearranged component so as not to overlap the device operation permission region 400.

FIG. 15B is a diagram illustrating the method of rearranging the component of the device operation input region (first image) and displaying the rearranged component so as not to overlap the device operation permission region 400.

FIG. 16A is a diagram illustrating a method of rearranging the component of the device operation input region (first image) and displaying the rearranged component so as to be close to the device operation permission region (second image).

FIG. 16B is a diagram illustrating the method of rearranging the component of the device operation input region (first image) and displaying the rearranged component so as to be close to the device operation permission region (second image).

FIG. 17A is a diagram illustrating a method of easily returning the display state of the device operation permission region (second image) to an initial state after changing the display state from the initial state.

FIG. 17B is a diagram illustrating the method of easily returning the display state of the device operation permission region (second image) to the initial state after changing the display state from the initial state.

FIG. 17C is a diagram illustrating the method of easily returning the display state of the device operation permission region (second image) to the initial state after changing the display state from the initial state.

FIG. 18A is a diagram illustrating a state in which the device operation permission region (second image) and the device operation input region (first image) are collectively moved by a touch operation.

FIG. 18B is a diagram illustrating a state in which the touch operation is not performed for a predetermined time.

FIG. 18C is a diagram illustrating a state in which the device operation permission region is changed to an original display state.

FIG. 19A is a diagram illustrating a state in which the device operation permission region (second image) is moved by a touch operation.

FIG. 19B is a diagram illustrating a state in which an operation is performed on the device operation input region (first image) by the touch operation.

FIG. 19C is a diagram illustrating a state in which the display state of the device operation permission region is automatically returned to a state before the movement.

FIG. 20 is a diagram illustrating a state in which a touch operation performed on an overlapping portion between the device operation permission region (second image) and the device operation input region (first image) is received as input to the device operation permission region.

FIG. 21 is a diagram illustrating an example in which, in a case where a plurality of device operation permission regions (second images) and a plurality of device operation input regions (first images) are displayed, the device operation permission region and the device operation input region that are displayed at relatively close positions form a set.

FIG. 22 is a diagram illustrating an example in which, in a case where a plurality of device operation permission regions (second images) and a plurality of device operation input regions (first images) are displayed, the device operation permission region and the device operation input region that are displayed at relatively far positions form a set.

FIG. 23 is a diagram illustrating a method of displaying a set of the device operation permission region (second image) and the device operation input region (first image) associated with each device to enable operation of a plurality of devices.

FIG. 24A is a diagram illustrating an example in which, when a touch input operation on the device operation permission region (second image) is not performed, the device operation input region in which information related to device operation is displayed does not receive the touch input, and only a device selection region receives the touch input.

FIG. 24B is a diagram illustrating an example in which, when the touch input operation is performed on the device operation permission region, only the device operation input region in which the information related to the device operation is displayed receives the touch input, and the device selection region does not receive the touch input.

FIG. 25 is a diagram illustrating an example in which the device operation permission region (second image) includes a plurality of portions, which enables detection of the predetermined gesture performed by a touch input.

FIG. 26 is a flowchart illustrating details of a content of a procedure performed in enable condition determination processing S621.

FIG. 27A is a diagram illustrating an example in which the device operation permission region includes a plurality of layered portions.

FIG. 27B is a diagram illustrating a processing order in a case where display regions displayed so as to overlap each other are operated.

FIG. 28A is a diagram illustrating an example in which a figure displayed in the device operation permission region (second image) includes one first portion.

FIG. 28B is a diagram illustrating an example in which a figure displayed in the device operation permission region (second image) includes one first portion.

FIG. 28C is a diagram illustrating an example in which a figure displayed in the device operation permission region (second image) includes one first portion.

FIG. 28D is a diagram illustrating an example in which a figure displayed in the device operation permission region (second image) includes one first portion.

FIG. 28E is a diagram illustrating an example in which a figure displayed in the device operation permission region (second image) includes one first portion.

FIG. 29A is a diagram illustrating an example in which the operator edits the device operation permission region (second image) by using a template image.

FIG. 29B is a diagram illustrating an example in which the operator edits the device operation permission region (second image) by using the template image.

FIG. 30A is a diagram illustrating an example in which a figure displayed in the device operation permission region (second image) includes two first portions.

FIG. 30B is a diagram illustrating an example in which a figure displayed in the device operation permission region (second image) includes two first portions.

FIG. 30C is a diagram illustrating an example in which a figure displayed in the device operation permission region (second image) includes two first portions.

FIG. 30D is a diagram illustrating an example in which a figure displayed in the device operation permission region (second image) includes two first portions.

FIG. 31A is a diagram illustrating a display example in which the figure in FIG. 30A is horizontally inverted.

FIG. 31B is a diagram illustrating a display example in which the figure in FIG. 30A is rotated.

FIG. 32 is a diagram illustrating an example in which a displayed shape of the device operation permission region (second image) is changed according to a displayed shape of the figure.

FIG. 33A is a diagram illustrating a stage in which the contacting body has touched the first portion.

FIG. 33B is a diagram illustrating a stage in which the contacting body has moved to a display position of the second portion.

FIG. 33C is a diagram illustrating a stage in which the contacting body has moved to a display position of a third portion.

FIG. 34A is a diagram illustrating an example in which the figure displayed in the device operation permission region (second image) is changed in a case where a specific portion of the device operation permission region is touched.

FIG. 34B is a diagram illustrating an example in which the figure displayed in the device operation permission region (second image) is changed in a case where a specific portion of the device operation permission region is touched.

FIG. 35A is a diagram illustrating a state in which the device operation permission region (second image) is reduced by a gesture of a pinch operation.

FIG. 35B is a diagram illustrating a state in which the device operation permission region (second image) is enlarged by the gesture of the pinch operation.

FIG. 36A is a diagram illustrating a state before the device operation permission region (second image) is rotated by a rotation gesture.

FIG. 36B is a diagram illustrating a state after the device operation permission region (second image) is rotated by the rotation gesture.

FIG. 37A is a diagram illustrating an example in which a display state of a portion of a component of the figure displayed in the device operation permission region (second image) is changed.

FIG. 37B is a diagram illustrating the example in which the display state of the portion of a component of the figure displayed in the device operation permission region (second image) is changed.

FIG. 38A is a diagram illustrating an example in which a display position of the device operation permission region (second image) can be moved in a display screen by a gesture via the touch input.

FIG. 38B is a diagram illustrating an example in which the display position of the device operation permission region (second image) can be moved in the display screen by the gesture via the touch input.

FIG. 39A is a diagram illustrating an example in which the display position of the device operation permission region (second image) can be moved in the display screen by the gesture via the touch input.

FIG. 39B is a diagram illustrating an example in which the display position of the device operation permission region (second image) can be moved in the display screen by the gesture via the touch input.

FIG. 40A is a diagram illustrating an example in which the first portion for displaying information regarding permission of the touch input operation on the device operation input region (first image) and the second portion for receiving a change in the display state of the device operation permission region (second image) are displayed in the device operation permission region.

FIG. 40B is a diagram illustrating an example in which the first portion for displaying the information regarding permission of the touch input operation on the device operation input region (first image) and the second portion for receiving the change in the display state of the device operation permission region (second image) are displayed in the device operation permission region.

FIG. 41 is a flowchart illustrating a processing procedure in a case where processing related to a deadman function is executed.

FIG. 42 is a diagram illustrating an example in which it is determined that the operator is in a normal state (a deadman condition is not satisfied) in a case where a touch position in the figure remains in a substantially stationary state for a period longer than a predetermined time.

FIG. 43 is a diagram illustrating an example in which it is determined that the operator is in a normal state (the deadman condition is not satisfied) in a case where touches on the figure by a predetermined number of contacting bodies are detected simultaneously.

FIG. 44 is a diagram illustrating an example in which it is determined that the operator is in a normal state (the deadman condition is not satisfied) in a case where the touch position by the contacting body moves in the figure by a predetermined distance or more within a predetermined time.

FIG. 45 is a diagram illustrating an example in which it is determined that the operator is in a normal state (the deadman condition is not satisfied) in a case where a trajectory of the touch position on the figure by the contacting body surrounds a predetermined point by a predetermined angle or more.

FIG. 46 is a diagram illustrating Table 1 illustrating a correspondence between the gesture and the change in the display state.

FIG. 47 is a diagram illustrating a method of limiting a range in which the device operation permission region (second image) is movable by the touch input operation to a predetermined region that does not overlap the device operation input region (first image).

FIG. 48 is a diagram illustrating a method of moving the display position of the device operation permission region (second image) so as to follow movement of the touch position in the case of moving the touch position with time while touching the third portion that does not include the figure.

FIG. 49A is a diagram illustrating an example in which whether a touch on the first portion and a touch on the second portion are made by the same contacting body is detected, and in a case where it is detected that the touches are made by the same contacting body, it is determined that the touch input operation on the device operation input region (first image) is permitted.

FIG. 49B is a diagram illustrating an example in which whether the touch on the first portion and the touch on the second portion are made by the same contacting body is detected, and in a case where it is detected that the touches are made by the same contacting body, it is determined that the touch input operation on the device operation input region (first image) is permitted.

FIG. 49C is a diagram illustrating an example in which whether the touch on the first portion and the touch on the second portion are made by the same contacting body is detected, and in a case where it is detected that the touches are made by the same contacting body, it is determined that the touch input operation on the device operation input region (first image) is permitted.

### DESCRIPTION OF THE EMBODIMENTS

An input device and the like according to an embodiment of the present disclosure will be described with reference to the drawings. The embodiments described below are merely examples, and for example, detailed configurations can be appropriately changed and implemented by those skilled in the art without departing from the gist of the present disclosure.

In the drawings referred to in the following embodiments and description, elements denoted by the same reference numerals have similar functions unless otherwise specified. In the drawings, in a case where a plurality of the same elements are arranged, reference numeral and a description thereof may be omitted.

In addition, the drawings may be schematic for convenience of illustration and description, and thus, the shape, size, arrangement, and the like of elements in the drawings may not strictly match those of actual ones.

### Production System

As an embodiment in which the input device according to the embodiment is used as an operation panel, an example in which operation control of a production device is performed using the input device in a production system that manufactures an article will be described. First, an overall configuration of the production system will be described, and then a configuration and an operation of the operation panel serving as the input device capable of receiving touch input will be described. Furthermore, many aspects of a characteristic software switch displayed on a display screen of the operation panel to enable an operator to safely and efficiently operate the production device will be exemplified.

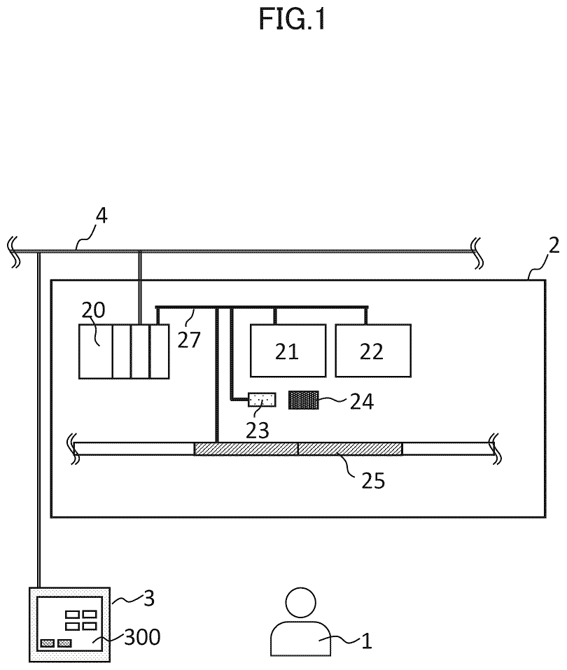

FIG. 1 is a schematic diagram illustrating the entire production system according to the embodiment, and the production system includes an operator 1, a production device 2, an operation panel 3, and a network 4. The operator 1 operates the production device 2 by using the operation panel 3. The production device 2 includes a programmable logic controller (PLC) 20, a control unit 21, a control unit 22, a sensor 23, a workpiece 24, a safety guard door 25, and an in-device network 27.

The control unit 21, the control unit 22, the sensor 23, and the safety guard door 25 are connected to the PLC 20 via the in-device network 27. The PLC 20 acquires information regarding a state of each equipment from each connected equipment and stores the information in an internal memory. The PLC 20 transmits an operation command to each equipment. The control unit 21 and the control unit 22 operate according to the operation command received from the PLC 20.

The sensor 23 detects information regarding the presence or absence of the workpiece 24 and a location of the workpiece 24 produced in the production device 2, and transmits a detection result to the PLC 20. The safety guard door 25 transmits information related to an opened/closed state of the safety guard door 25 to the PLC 20. When the safety guard door 25 is opened, the PLC 20 transmits a command to perform, for example, a stop operation to each connected equipment in the production device 2.

The operation panel 3 includes a display unit 300 serving as a display screen capable of receiving the touch input, and is connected to the PLC 20 via the network 4. The display unit 300 can display, for example, information regarding the control unit 21, the control unit 22, the sensor 23, and the safety guard door 25 in the production device 2, the information being transmitted from the PLC 20. The operation panel 3 can detect the touch input on the display screen by the operator 1, and for example, the operation panel 3 can transmit, to the PLC 20, the operation command for the production device 2, the operation command being input by the operator 1. The PLC 20 that has received the operation command from the operation panel 3 drives a device in the production device 2 according to the operation command. The operation panel 3 may be connected to a PLC of another production device, a computer or a data bus in the system, an external network, an external computer, or the like via the network 4.

### Operation Panel

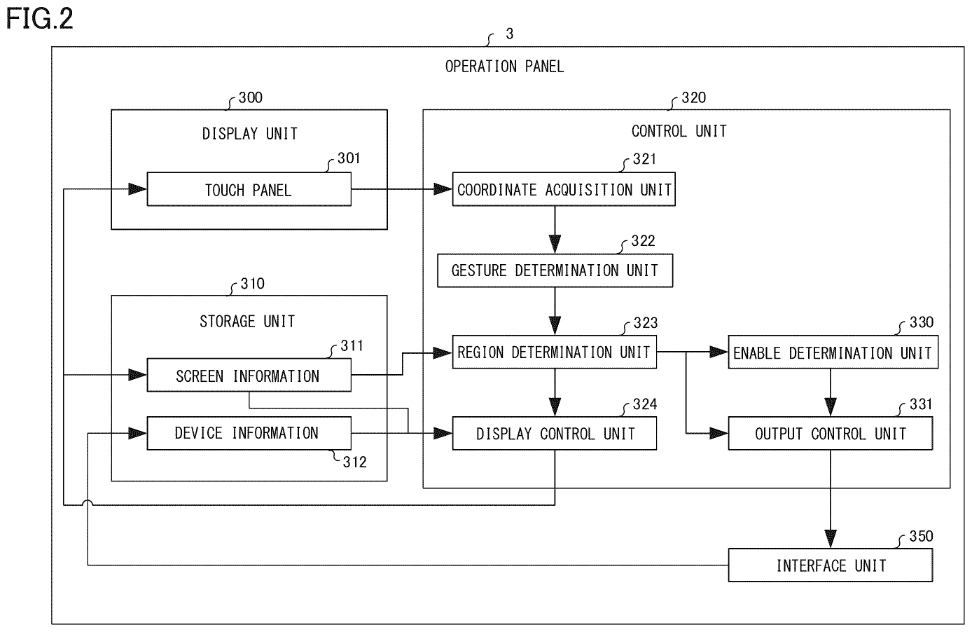

FIG. 2 is a block diagram illustrating a configuration of the operation panel 3 serving as the input device according to the embodiment. In FIG. 2, functional elements necessary for describing characteristics of the present embodiment are represented by functional blocks, but a description of general functional elements not directly related to the principle for solving the problems according to the present disclosure is omitted. In addition, each functional element illustrated in FIG. 2 is functionally conceptual, and does not necessarily have to be physically configured as illustrated. For example, a specific form of distribution or integration of the functional blocks is not limited to the illustrated example, and all or some of the functional blocks can be functionally or physically distributed and integrated in arbitrary units according to a use situation or the like. Each functional block can be configured using hardware or software.

The operation panel 3 includes the display unit 300, a storage unit 310, a control unit 320, and an interface unit 350. The operation panel 3 is communicably connected to a host controller via the interface unit 350. An operation status of various devices in the production device can be displayed on the display unit 300 based on information input from the host controller. In the example of FIG. 1, the PLC 20 corresponds to the host controller. The host controller has a function of controlling the operation status of the production device by monitoring the operation status of the production device and transmitting the operation command to various devices as necessary. The host controller that can be connected to the operation panel 3 is not limited to the PLC 20, and may be, for example, a personal computer (PC) attached to various types of devices, a temperature controller, other arithmetic units, or the like.

As described above, the operation panel 3 has a function of displaying the operation status of the production device and transmitting a control command to the host controller or the device of the production device, and thus serves as a control panel in the production device. The operation panel 3 may be a tablet device including a touch panel or a programmable display.

The display unit 300 includes a touch panel 301. The touch panel 301 includes a display surface that displays an image or the like, a sensor that detects a touch when a contacting body is brought into contact with the display surface, and a sensor that detects a touched position. The touch refers to a state in which the contacting body (for example, a finger of the operator or a stylus) is in contact with the touch panel 301, and in some cases, refers to a state in which the contacting body is in close contact with the touch panel 301. A detection method is not limited as long as the sensor has a function of detecting the touch and the touched position. When the touch is detected, for example, it is assumed that information such as a command has been input by the operator, and information related to the touch is transmitted to the control unit 320.

The touch panel 301 is desirably a device capable of detecting a so-called multi-touch. Detecting the multi-touch means detecting touches simultaneously made by a plurality of contacting bodies. The contacting body can touch the touch panel, and is, for example, a finger of the operator or the stylus.

The touch panel 301 can be configured such that, for example, in a case where there are a contacting body A and a contacting body B, which are different contacting bodies, a touch made by the contacting body A and a touch made by the contacting body B can be distinguished and detected without confusion. For example, in a case where the contacting body A moves a touch position while maintaining contact, the touch panel 301 tracks the movement of the touch position and continuously detects that the touch made by the contacting body A is maintained. Such an operation in which the contacting body moves the touch position while maintaining contact with the touch panel 301 may be referred to as a gesture, and in the following description, the operation may refer to touching the touch panel 301 or performing a gesture on the touch panel 301.

The control unit 320 is a computer that controls the operation panel 3 serving as the input device, and includes therein a central processing unit(CPU), a read only memory (ROM), a random-access memory (RAM), an input/output (I/O) port, and the like (not illustrated). The ROM stores an operation program of the operation panel 3. A program for executing various types of processing according to a control method for the operation panel 3 serving as the input device may be stored in the ROM similarly to other operation programs, but may be loaded from the outside into the RAM via a network. Alternatively, the program may be loaded into the RAM via a computer-readable recording medium in which the program is recorded. A processing program of the CPU for implementing the control method can be supplied to each of the above-described storage units via a storage portion such as various magnetic disks, optical disks, and flash memories and a drive device therefor, and can update contents thereof. Various storage portions, storage units, or storage devices storing programs capable of executing processing in the CPU for implementing the control method for the operation panel 3 are computer-readable recording media according to the control method or the input device of the present disclosure.

In FIG. 2, functional blocks for causing the operation panel 3 to function are illustrated in the control unit 320, and each functional block can be configured using software or hardware such as an application-specific integrated circuit (ASIC).

The control unit 320 includes a display control unit 324, and the display control unit 324 has a function of controlling display on the touch panel 301. In addition, the control unit 320 includes an output control unit 331, and the output control unit 331 has a function of outputting an operation instruction to the host controller via the interface unit 350. Here, a case where the display control unit 324 is mounted on the control unit 320 of the operation panel 3 will be described as an example, but the embodiment of the present disclosure is not limited thereto. For example, the display control unit 324 may be mounted on a control device separate from the operation panel 3 so as to be able to communicate with the control unit 320 of the operation panel 3.

The control unit 320 is communicably connected to the display unit 300, and can receive information regarding the touch input detected by the touch panel 301. The information regarding the touch input may include identification information of the contacting body currently touching, the number of contacting bodies currently touching, the touch position of each contacting body, a time when each contacting body touches, and the like. A coordinate acquisition unit 321, a gesture determination unit 322, and a region determination unit 323 can be collectively referred to as a touch input detection unit.

The coordinate acquisition unit 321 generates information (coordinate information) indicating which position on a displayed control panel image has been touched by the contacting body based on touch information acquired from the touch panel 301. The information may be coordinates corresponding to an image display position of the control panel image displayed on the display unit 300. For example, in a display such as a liquid crystal panel configured as the display surface of the touch panel 301, a position of a pixel arranged at the left uppermost position can be set as an origin of the display unit 300. Then, the image display position of the control panel image displayed on the display unit 300 is set as a control panel image position, and coordinates based on the origin can be set. The control panel image does not need to be arranged at the origin of the display surface, and can be arranged at an appropriate position in the display screen according to the convenience of the operator. The control panel image that can be displayed on the display unit in the present embodiment has many aspects, and will be specifically described below with reference to the drawings.

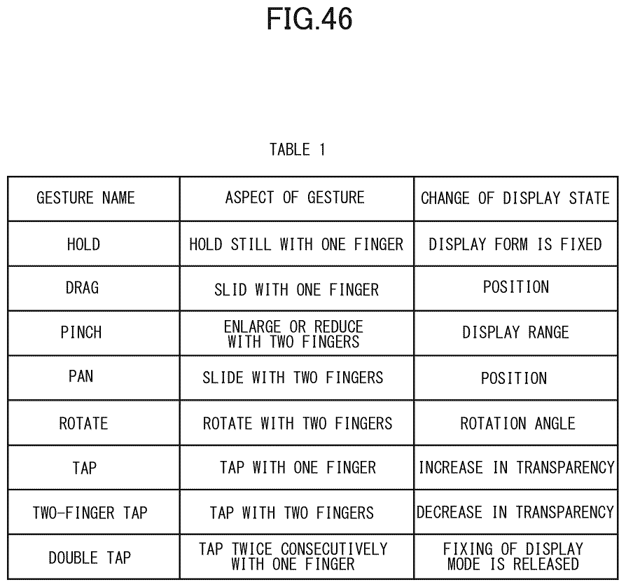

The gesture determination unit 322 determines whether or not a touch operation performed by the operator is a gesture, based on the coordinate information generated by the coordinate acquisition unit 321. The gesture is described below with reference to FIG. 46 and the like. In a case where the touch panel 301 is touched by a plurality of contacting bodies, it is possible to determine which contacting body corresponds to each touch position. Therefore, the coordinate acquisition unit 321 determines which contacting body corresponds to the coordinate information of the touch, and transmits a determination result to the gesture determination unit 322 together with the coordinate information. Therefore, the gesture determination unit 322 can distinguish each contacting body and acquire information regarding the gesture.

In a case where a predetermined specific gesture is detected, the gesture determination unit 322 transmits the coordinate information and gesture information as a command to the region determination unit 323. The gesture information includes a type of the gesture and information regarding coordinates at which the gesture is performed by the touch input. In addition, in a case where the predetermined specific gesture is not detected, only information regarding coordinates at which the touch is detected is transmitted to the region determination unit 323.

Based on the coordinate information and the gesture information received from the gesture determination unit 322 and screen information 311 acquired from the storage unit 310, the region determination unit 323 determines in which region on the control panel image a touch input operation has been performed. The region and the region determination unit 323 are described in detail below. The region determination unit 323 outputs a determination result to the display control unit 324, an enable determination unit 330, and the output control unit 331.

The display control unit 324 changes an image to be displayed on the touch panel 301 based on device information 312, the screen information 311 stored in the storage unit 310, and the coordinates at which the touch operation has been performed, the coordinates being received from the region determination unit 323. The screen information 311 includes the operation command corresponding to a switch and operation information of a device corresponding to a lamp, in addition to display forms (display forms such as the number, a size, and a color) of the switch and the lamp. The display control unit 324 changes the screen information 311 according to an operation content and the operation information of the device included in the device information 312, and then displays the screen information 311 on the display unit. For example, a turned-on lamp is displayed on the screen. The enable determination unit 330 and the output control unit 331 are described below in detail.

When the operation command is received from the output control unit 331, the interface unit 350 generates an operation command message using a communication protocol based on the operation command. The generated operation command message is transmitted to the host controller. The operation command given from the output control unit 331 is a signal for operating the host controller or a device connected to the host controller. In addition, the interface unit 350 is communicably connected to the host controller in a wired or wireless manner.

Next, the control panel image displayed on the display screen of the touch panel 301 and the functions of the region determination unit 323, the enable determination unit 330, and the output control unit 331 will be described in detail with reference to the drawings. The control panel image refers to an image displayed on the display screen of the touch panel 301 in order to operate the production device 2.

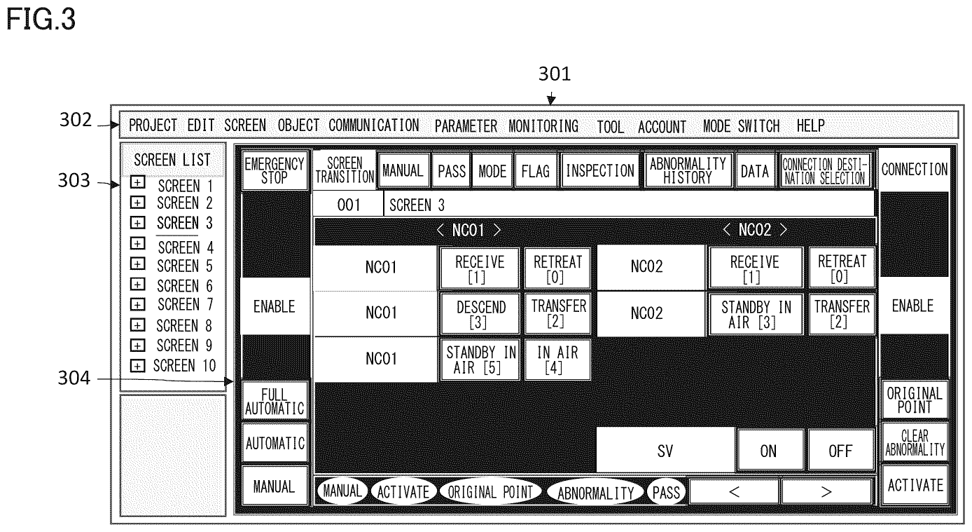

FIGS. 3 to 5 are explanatory views illustrating the control panel images displayed on the touch panel 301 of the operation panel 3 in association with operation stages (operation modes). The operation stages (operation modes) may include an editing stage (editing mode) and a device operation stage (device operation mode). The editing stage (editing mode) is a stage of editing the screen information 311 to create/change a layout of the control panel image and correspondence information of the switch, and the device operation stage (device operation mode) is a stage of actually controlling operation of the production device 2 by using the operation panel 3.

FIG. 3 illustrates an image that can be displayed on the touch panel 301 of the display unit 300 in the editing stage. The image includes a menu bar 302, a screen list 303, and a control panel image preview display 304. In the menu bar 302, items for enabling access to necessary tools in each operation stage are arranged. A list of the control panel images is displayed in the screen list 303. In the control panel image preview display 304, a preview of the control panel image displayed in the device operation stage is displayed.

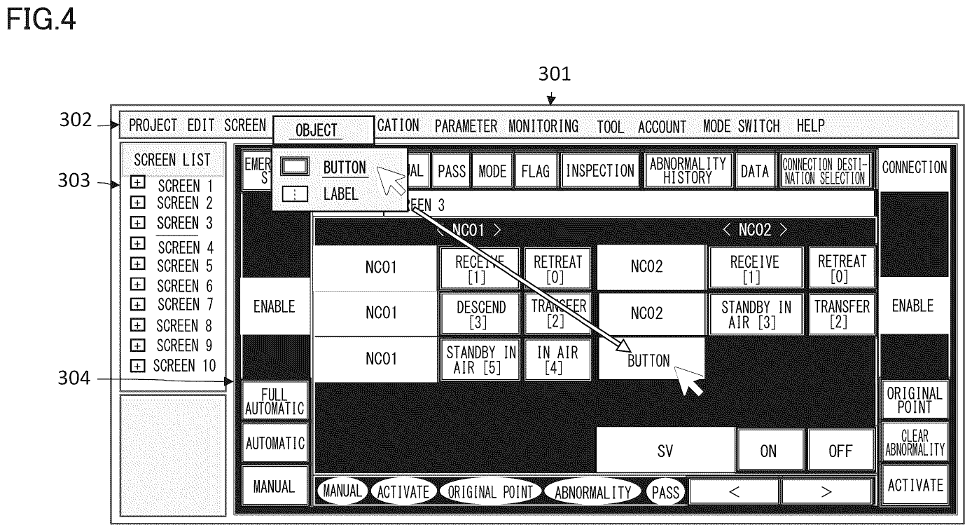

FIG. 4 is a view illustrating editing work in the editing stage, and illustrates the touch input operation in a case where a button is newly created. An “object” indicating an object tool is selected from the menu bar 302, and a “button” is added by selecting a button icon displayed in the extended menu bar 302.

The display unit 300 displays a screen on which a display object indicating a state of the production device 2, an operation object for generating the operation command, and a screen transition object for switching a screen to be displayed are arranged. The following is an example of the object displayed on the control panel image.

### Display Object

Lamp: An indicator object that indicates ON/OFF of information.
Label: An indicator object that indicates information in a text form.

### Operation Object

Button: An operation object to be turned ON/OFF.
Slide bar: An operation object including a moving body that performs a linear operation.
Stick: An operation object including a moving body that performs a directional operation.

### Screen Transition Object

Screen transition button: An object for performing screen transition of the control panel image.

### Data Input Object

Text box: An object for text input or numerical value input.

### Arrangement Object

Table layout panel: A panel object for aligning objects. The objects can be arranged in rows and columns.

When a saving tool is selected from the menu bar 302, the storage unit 310 stores a change content of the screen information 311. In addition, switching of each operation stage can be performed by selecting an operation stage switching tool from the menu bar 302, and at this time, the storage unit 310 may store the screen information 311.

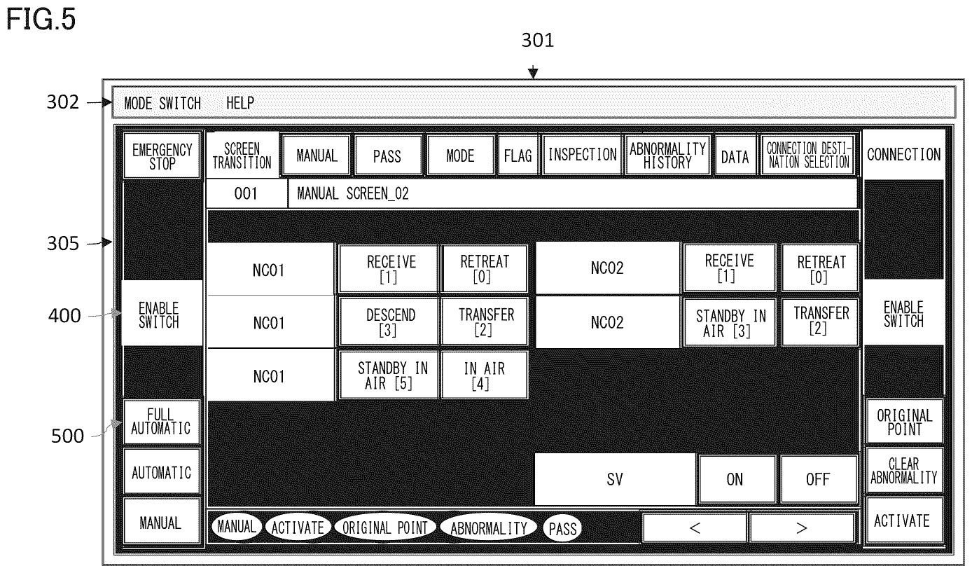

FIG. 5 illustrates a control panel image 305 displayed on the touch panel 301 of the display unit 300 in the device operation stage (device operation mode). The control panel image 305 includes the menu bar 302, an enable switch (which may hereinafter be referred to as a device operation permission region 400), and an object (which may hereinafter be referred to as a device operation input region 500). In the description of the embodiment, the enable switch or the device operation permission region 400 refers to a software switch that is displayed on the touch panel 301 of the display unit 300 and has a function of permitting input to the device operation input region 500, unlike a mechanical enable switch having a three-position mechanism according to the related art.

In a case where the device operation permission region 400 and the device operation input region 500 are displayed in a state of being divided into a plurality of regions, each of the regions is treated as an individual object. For example, in a case where the device operation input region 500 is divided into two regions, one region may be a button and the other region may be a different object such as a label, or the two regions may be buttons and respectively correspond to different operation commands.

Here, a flow of information processing from when the touch panel 301 is operated by the operator via the touch input to when the operation command is transmitted to the host controller will be briefly described with reference to FIG. 2 again. The screen information 311 stores correspondence information between a switch arranged on the control panel image 305 and the operation command output by operating the switch. For example, it is assumed that an activation switch associated with an activation operation command is arranged on the control panel image. In a case where the host controller is the PLC 20, a sequence program is operated so as to enable an operation of activating a connected device, and the activation operation is started when activation start command bit data allocated in the memory is turned on. That is, the activation operation command is a command to turn on the activation start command bit data of the host controller. The output control unit 331 outputs the activation operation command to the host controller or the device. The interface unit 350 generates the operation command message based on the communication protocol to communicate with the host controller, and communicates with the host controller. In the host controller, the activation operation is performed when the activation start instruction bit data is turned on.

The region determination unit 323 acquires the coordinate information regarding the touch input from the coordinate acquisition unit 321. In addition, the region determination unit 323 acquires, from the screen information 311, information indicating a range corresponding to display regions of the device operation permission region 400 and the device operation input region 500 displayed on the control panel image. Based on such pieces of information, the region determination unit 323 identifies for which region the coordinates at which the touch operation has been performed are input, and generates region information. The region information includes information indicating a region on which the touch operation is being performed on the control panel image and a type of the object in the region.

In a case where it is determined that an operation is being performed on the device operation permission region 400 and the operation satisfies an enable condition, the enable determination unit 330 determines that enablement is valid. The valid enablement means that information subjected to the touch input in the device operation input region 500 is enabled. The enable condition is described below in detail.

In a case where the touch operation is performed on the device operation input region 500, the output control unit 331 outputs the operation command for a device corresponding to the device operation input region 500 only when the enable determination unit 330 has determined that the enablement is valid. In other words, in order for the operator 1 to output the operation command to the production device 2, it is necessary to perform the touch operations on the device operation permission region 400 and the device operation input region 500 at the same time and perform the touch operation on the device operation permission region 400 so as to satisfy the enable condition. By doing so, an accurate command is issued to the production device 2, and the production device 2 is prevented from operating in an uncontrolled manner due to an erroneous touch by the operator, a deadman state described below, or the like.

### Control Method for Input Device

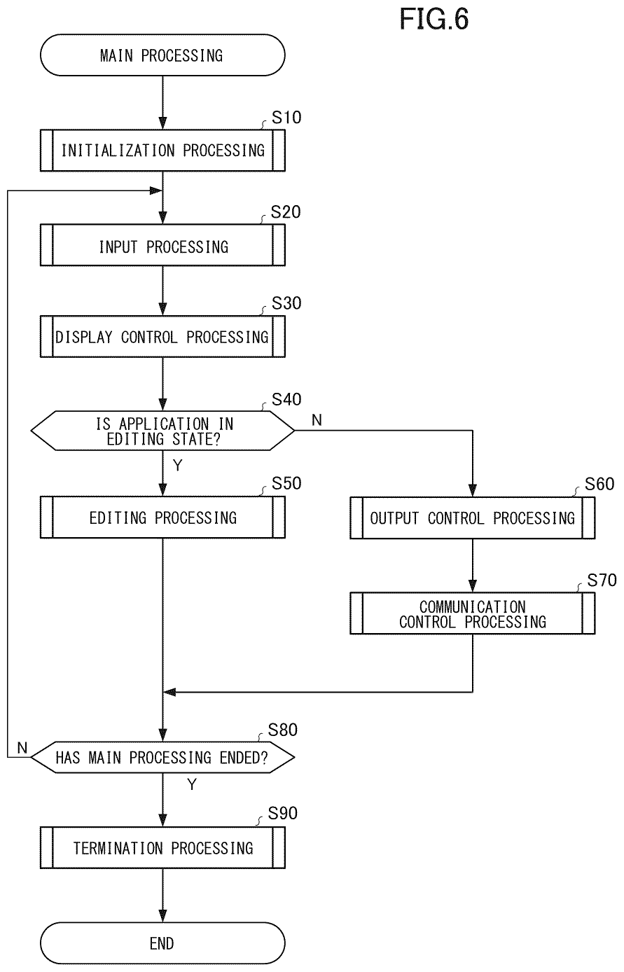

A control method for the input device according to the present embodiment will be described. FIG. 6 is a flowchart illustrating an operation of main processing. The main processing is a series of operations from the activation of the operation panel 3 to the end of the information processing, and is started when an application that executes the main processing is activated. In addition, when the activation of the application ends, the main processing also ends. The main processing is executed by the control unit 320.

In initialization processing S10, initialization for the main processing is performed. In the initialization processing S10, information necessary for starting the main processing is read. Specifically, the control unit 320 acquires the information in the screen information 311 of the storage unit 310.

In input processing S20, processing related to the input to the touch panel 301 is executed. As illustrated in FIG. 6, the input processing S20 and display control processing S30 are started after the initialization processing S10, and are continuously restarted until it is determined in step S80 that the main processing has ended.

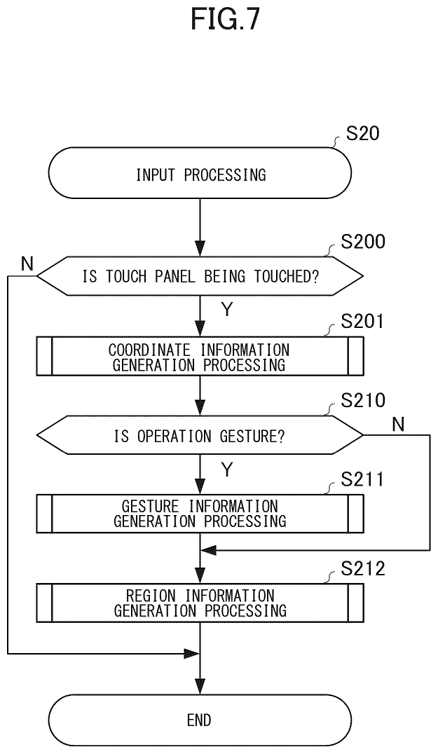

FIG. 7 is a flowchart illustrating a procedure in the input processing S20 in detail. In step S200, the display control unit 324 determines whether or not the touch panel 301 is being touched by the contacting body. The touch panel 301 includes the sensor that determines whether or not the touch panel 301 is being touched. In a case where the touch panel 301 is being touched, the touch information is transmitted from the touch panel 301 to the control unit 320. The touch information can be transmitted for each contacting body, or pieces of information for all the contacting bodies may be simultaneously transmitted to the control unit 320.

In a case where the touch panel 301 is not being touched (step S200: NO), the processing ends. In a case where the touch panel 301 is being touched (step S200: YES), the processing proceeds to step S201, and the display control unit 324 receives the coordinate information generated by the coordinate acquisition unit 321.

Next, in step S210, the gesture determination unit 322 determines whether or not the touch operation is a gesture. In a case where the touch operation is a gesture (step S210: YES), the processing proceeds to step S211, and the display control unit 324 acquires the gesture information generated by the gesture determination unit 322. In a case where the touch operation is not a gesture (step S210: NO), the gesture information is not generated by the gesture determination unit 322, and thus, the gesture information is not acquired. Next, in step S212, the display control unit 324 acquires the region information generated by the region determination unit 323.

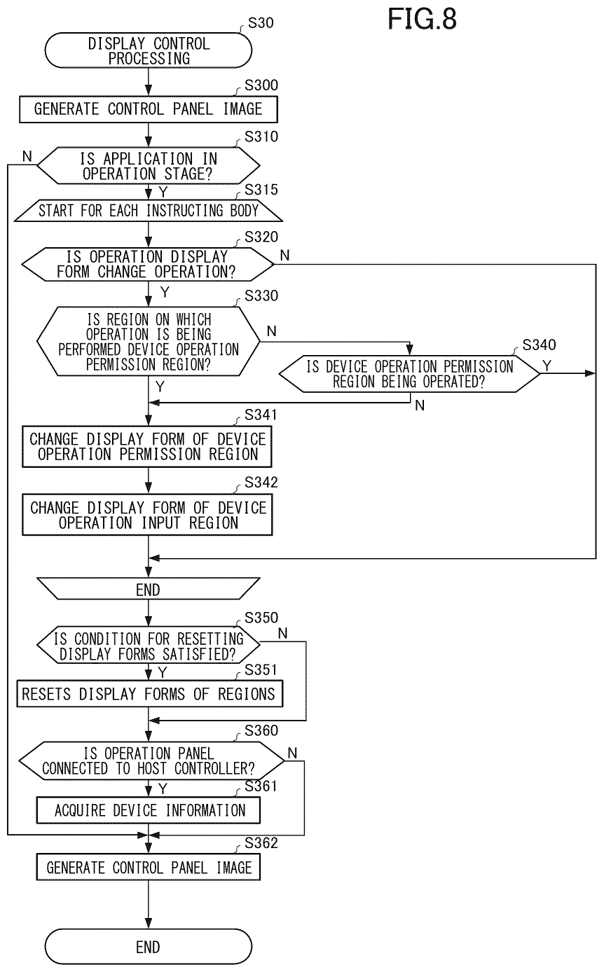

Returning to FIG. 6, in the display control processing S30 subsequent to the input processing S20, processing related to display control of the control panel image is executed. FIG. 8 is a flowchart illustrating a procedure of the display control processing S30 in detail. In step S300, the display control unit 324 generates the control panel image by using the screen information 311 acquired by the application in the initialization processing S10, and displays the control panel image on the display unit 300.

Next, in step S310, the display control unit 324 determines whether the operation stage (operation mode) of the application is the editing stage (editing mode) or the device operation stage (device operation mode). In a case where the operation stage is the editing stage (step S310: NO), the processing ends.

In a case where the operation stage is the device operation stage (step S310: YES), the processing continues and proceeds to step S315. In step S315, the processing from step S320 to step S362 is repeatedly executed for each contacting body based on the acquired touch information, coordinate information, gesture information, and region information generated for each contacting body until the processing ends.

In step S320, the display control unit 324 determines whether or not the operation is a display form change operation. A display form of the region includes a display range, a display position, a color, a transparency, a rotation angle, a shape, and display/non-display. The “display form” in the following description may be paraphrased as a “display state”. The display form change (display state change) operation is described below in detail.

In a case where the operation is not the display form change operation (step S320:
NO), the display control unit 324 does not change display forms of the device operation permission region 400 and the device operation input region 500 at all. In a case where the operation is the display form change operation (step S320: YES), the processing proceeds to step S330, and the display control unit 324 determines whether or not the region on which the operation is being performed is the device operation permission region 400 based on the region information acquired in step S212.

In a case where the region on which the operation is being performed is the device operation permission region 400 (step S330: YES), the processing proceeds to steps 341 and 342, and the display control unit 324 changes the display forms of the device operation permission region 400 and the device operation input region 500 according to the operation. A display form change method is described below in detail.

In a case where the region on which the operation is being performed is not the device operation permission region 400 (step S330: NO), the processing proceeds to step S340, and it is determined whether or not the device operation permission region 400 is being operated. In a case where the current operation is being performed on a region other than the device operation permission region 400 and the device operation permission region 400 is already being operated (step S340: YES), the display control unit 324 does not change the display forms of the device operation permission region 400 and the device operation input region 500 at all. Specifically, in a case where the touch panel 301 is being touched by a plurality of contacting bodies at the same time, a plurality of pieces of region information for the respective contacting bodies are generated by the region determination unit 323. At this time, the device operation permission region 400 may already be operated by another contacting body depending on an execution timing in step S315. In this case, the display control unit 324 does not change the display forms of the device operation permission region 400 and the device operation input region 500 at all. In a case where the device operation permission region 400 is not being operated (step S340: NO), the processing proceeds to step S341 described above.

Once the processing from step S320 to step S362 ends, in step S350, the display control unit 324 determines whether or not a condition for resetting the display forms is satisfied. The condition for resetting the display forms is described below in detail. In a case where the condition for resetting the display forms is not satisfied (step S350: NO), the display control unit 324 does not change the display forms of the device operation permission region 400 and the device operation input region 500 at all.

In a case where the condition for resetting the display forms is satisfied (step S350: YES), the processing proceeds to step S351, and the display control unit 324 resets the display forms of the device operation permission region 400 and the device operation input region 500 changed in steps S341 and S342. The resetting refers to changing the current display form of each region to the display form before the past change. Specifically, the screen information 311 acquired in step S300 includes information regarding the display form of each region before the change, and the display form is reset using the information.

Next, in step S360, the display control unit 324 determines whether or not the operation panel 3 is connected to the host controller. In a case where the operation panel 3 is connected to the host controller (step S360: YES), in step S361, the display control unit 324 acquires the device information 312 stored in the storage unit 310 by the interface unit 350.

In a case where the operation panel 3 is not connected to the host controller (step S360: NO), the display control unit 324 does not acquire the device information 312. The display control unit 324 may acquire the device information 312 regardless of the determination result in step S360.

Next, in step 362, the display control unit 324 generates and displays the control panel image. Specifically, the display control unit 324 generates an image obtained by changing the control panel image generated in step S300, based on display form change results for the device operation permission region 400 and the device operation input region 500 in steps 341 and 342, a region display form resetting result in step S351, and an acquisition result for the device information 312 in step S361, and displays the generated image on the display unit 300.

Returning to FIG. 6, in step S40 subsequent to the display control processing S30, it is determined whether the application is in the editing stage or the operation stage. In a case where the application is in the editing stage (step S40: YES), in editing processing S50, the control unit 320 executes processing of the application in the editing stage.

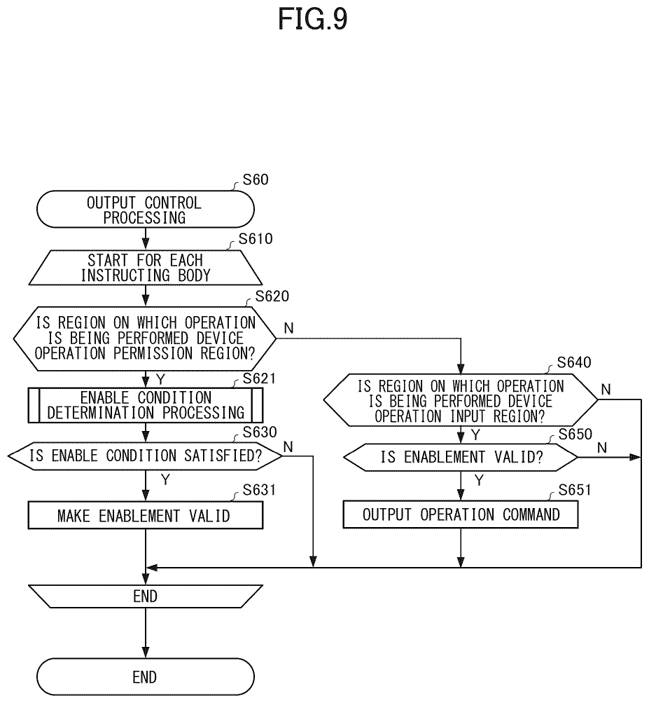

In a case where the application is in the operation stage (step S40: NO), the control unit 320 executes processing related to output control of the operation panel 3 in output control processing S60. FIG. 9 is a flowchart illustrating a processing procedure of the output control processing S60.

In FIG. 9, in step S610, the output control unit 331 repeatedly executes steps S620 to S651 for each contacting body based on the acquired touch information, coordinate information, gesture information, and region information generated for each contacting body until the processing ends.

In step S620, the output control unit 331 determines whether or not the region on which the operation is being performed is the device operation permission region 400 based on the region information acquired in step S212.

In a case where the region on which the operation is being performed is the device operation permission region 400 (step S620: YES), the output control unit 331 proceeds to enable condition determination processing S621 and executes processing of determining whether or not the enable condition is satisfied by the currently performed operation. The enable condition may be a condition that the operation performed on the device operation permission region 400 corresponds to any one of a touch and a gesture.

When the enable condition determination processing S621 starts, in step S630, the output control unit 331 determines whether or not the enable condition is satisfied. In a case where the enable condition is satisfied (step S630: YES), the processing proceeds to step S631, and the output control unit 331 makes the enablement valid. In the case of determining whether or not the enable condition is satisfied in step S630, the output control unit 331 may determine whether the enablement is valid for each device operation input region 500. Specifically, it is determined whether or not the enable condition is satisfied for each device operation input region 500 according to the display form of any one of the device operation permission region 400 and the device operation input region 500, a positional relationship between display ranges of the respective regions, and a correspondence relationship between the respective regions. In other words, the device operation input region 500 for which the enablement is valid and the device operation input region 500 for which the enablement is invalid may be mixed depending on the positional relationship between the device operation permission region 400 and the device operation input region 500 and the display forms. The determination as to whether or not the enable condition is satisfied is described below in detail.

In a case where it is determined in step S620 that the region on which the operation is being performed is not the device operation permission region 400 (step S620: NO), the output control unit 331 determines in step S640 whether or not the region on which the operation is being performed is the device operation input region 500. In a case where the region on which the operation is being performed is the device operation input region 500 (step S640: YES), the output control unit 331 determines whether or not the enablement is valid in step S650.

In a case where the enablement is valid (step S650: YES), the output control unit 331 outputs the operation command in step S651. In other words, in a case where the device operation permission region 400 and the device operation input region 500 have already been operated at the same time, if the device operation permission region 400 satisfies the enable condition, the operation command is output by the processing of step S651 by the operation of the device operation input region 500.

Returning to FIG. 6, in communication control processing S70 subsequent to the output control processing S60, the control unit 320 executes processing related to communication control of the interface unit 350. Specifically, the operation command message is generated based on a processing result of the output control processing S60, and the operation command message is transmitted to the host controller via the interface unit 350. In addition, the interface unit 350 acquires the device information 312 from the host controller and stores the device information 312 in the storage unit 310. In step S80 of FIG. 6, it is determined whether or not the main processing has ended. In a case where the main processing has ended (step S80: YES), the control unit 320 executes processing related to the end of the main processing in termination processing S90.

### Various Display Aspects of Control Panel Image

Hereinafter, various display aspects of the control panel image displayed on the display screen in the device operation mode in the input device according to the embodiment will be described with reference to the drawings. It is assumed that the operator needs to perform the touch input on both the device operation permission region 400 and the device operation input region 500 displayed on the control panel image in order to output the operation command from the operation panel 3 serving as the input device to the production device 2 in the device operation mode. First, configurations and effects of first to thirty-second embodiments will be briefly described, and then specifically described with reference to the drawings.

### First Embodiment

A first embodiment is an input device including:
a display screen having a touch input function;
a display control unit configured to control an image displayed on the display screen; and
a touch input detection unit configured to detect a touch input operation on the display screen, in which
in a device operation mode in which information regarding an operation of a device is inputtable by a user performing the touch input operation on the display screen, the display control unit is configured to display, on the display screen, a first image indicating information regarding the device and a second image indicating information regarding permission of the touch input operation on the first image, and to change a display state of the second image according to a detection result of the touch input detection unit.

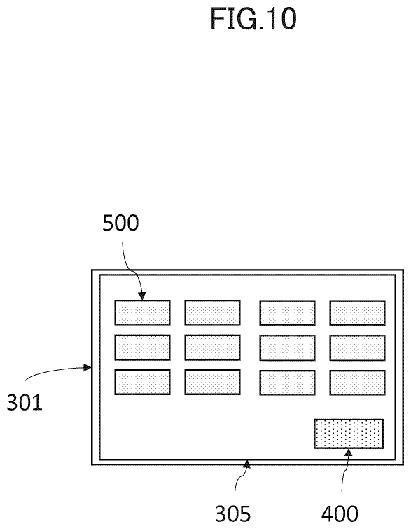

In the present embodiment, for example, the display position of the enable switch (second image) can be moved or the form of the enable switch (second image) can be changed by a simple touch operation in the device operation stage. For example, the enable switch (second image) and the device operation input region (first image) can be arranged in a range in which the operator can simultaneously operate the enable switch and the device operation input region with one hand, so that an effect of high operability is achieved. The present embodiment will be specifically exemplified by the following description with reference to FIGS. 10, 11A, 11B, 45, and the like.

### Second Embodiment

A second embodiment is the input device according to the first embodiment, in which the display control unit is configured to change the display state of the second image in a case where the touch input detection unit receives the touch input operation on the second image.

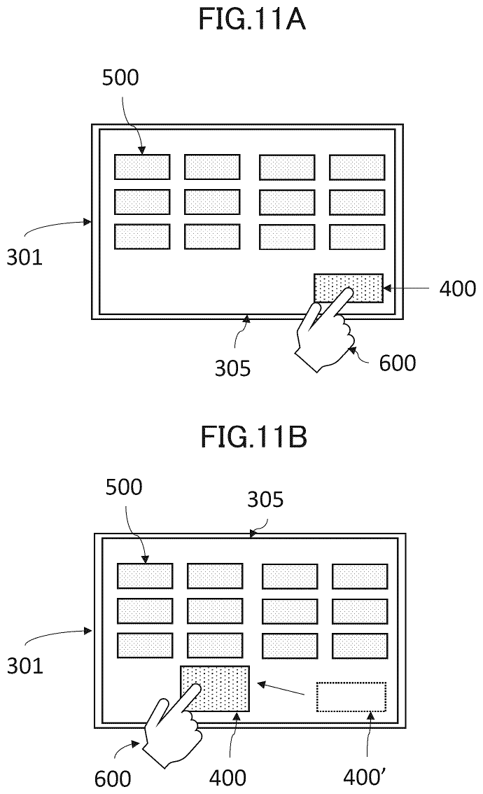

In the present embodiment, for example, the operator can easily manually move the display position of the enable switch (second image) by performing the touch input on the enable switch (second image). For example, the enable switch (second image) and the device operation input region (first image) can be arranged in a range in which the operator can simultaneously operate the enable switch and the device operation input region with one hand, so that an effect of high operability is achieved. The present embodiment will be specifically exemplified by the following description with reference to FIGS. 10, 11A, 11B, and the like.

### Third Embodiment

A third embodiment is the input device according to the first or second embodiment, in which in a case where the touch input detection unit detects the touch input operation on the first image and does not detect the touch input operation on the second image, the display control unit is configured to move a display position of the second image so as to approach a position at which the touch input operation is detected in the first image.

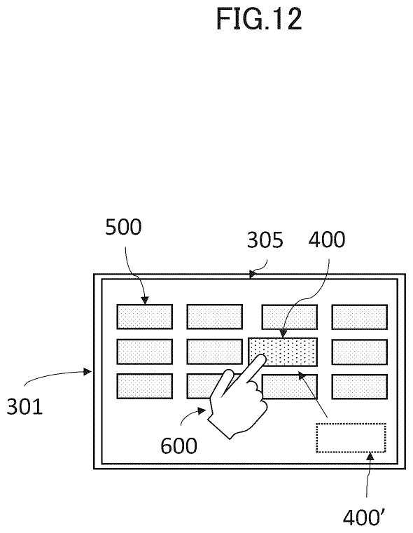

In the present embodiment, it is possible to easily move the enable switch (second image) to a position at which the operator can easily perform the touch input operation, so that an effect of facilitating the operation of the enable switch is achieved. The present embodiment will be specifically exemplified by the following description and the like with reference to FIG. 12.

### Fourth Embodiment

A fourth embodiment is the input device according to the first or second embodiment, in which in a case where the touch input detection unit detects the touch input operation of moving a touch position with time while touching the first image and does not detect the touch input operation on the second image, the display control unit is configured to move a display position of the second image so as to follow the movement of the touch position in the first image.

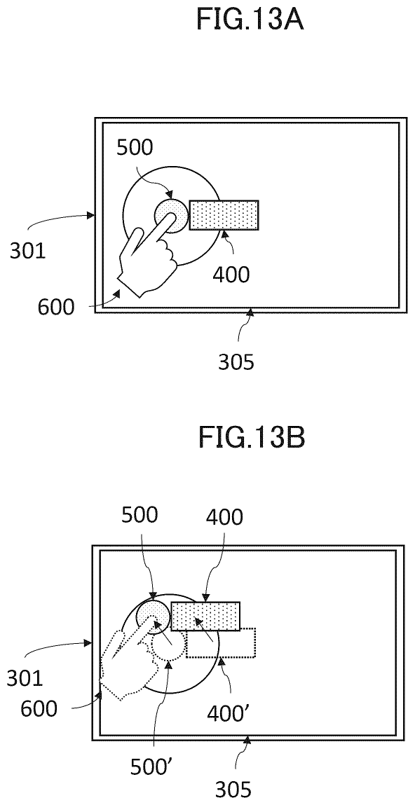

In the present embodiment, since the enable switch (second image) is displayed so as to follow the movement of the touch position in the device operation input region (first image), a positional relationship in which simultaneous operation of the device operation input region (first image) and the enable switch (second image) is easy is maintained. Therefore, an effect of enabling the operator to easily perform the touch input operation is achieved. The present embodiment is specifically exemplified by the following description and the like with reference to FIGS. 13A and 13B.

### Fifth Embodiment

A fifth embodiment is the input device according to any one of the first to fourth embodiments, in which in a case where the touch input detection unit detects the touch input operation on a position at which the first image is not displayed in a state in which the display control unit displays the first image on the display screen and does not display the second image, the display control unit is configured to display the second image at a position at which the touch input operation is detected.

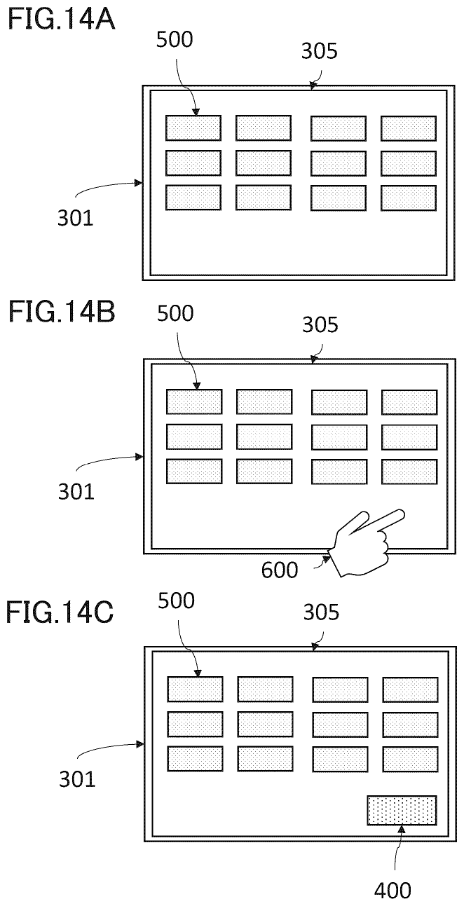

According to the present embodiment, the operator can easily arrange the enable switch (second image) by the touch input at an easily operable position on the display screen. In addition, since it is sufficient if the enable switch (second image) is displayed when the operator considers that it is necessary to display the enable switch, an effect of high utilization efficiency of the display screen is achieved. The present embodiment is specifically exemplified by the following description and the like with reference to FIGS. 14A to 14C.

### Sixth Embodiment

A sixth embodiment is the input device according to any one of the first to fifth embodiments, in which
the display control unit is configured to display, on the display screen, a reset switch for receiving a command to change the display state of the second image that is being displayed to a predetermined display state set in advance, and
the display control unit is configured to change the display state of the second image to the predetermined display state in a case where the touch input detection unit detects the touch input operation on the reset switch.

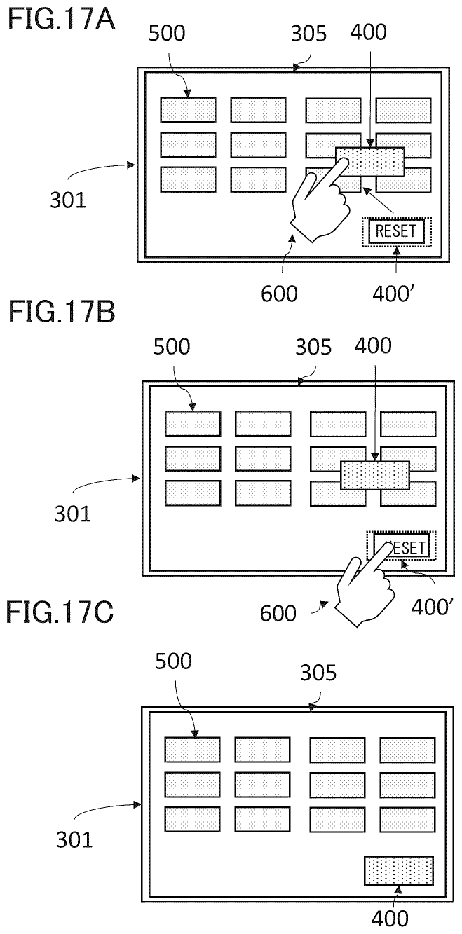

In the present embodiment, for example, the operator can easily return the display state of the enable switch (second image) to the original display state (for example, a home position) after changing the display state of the enable switch (second image) from the predetermined display state, and thus, an effect of high operability is achieved. The present embodiment is specifically exemplified by the following description and the like with reference to FIGS. 17A to 17C.

### Seventh Embodiment

A seventh embodiment is the input device according to any one of the first to sixth embodiments, in which in a case where a time during which the touch input detection unit detects no touch input operation on either the first image or the second image exceeds a predetermined time, the display control unit is configured to change the display state of the second image to a predetermined display state set in advance.

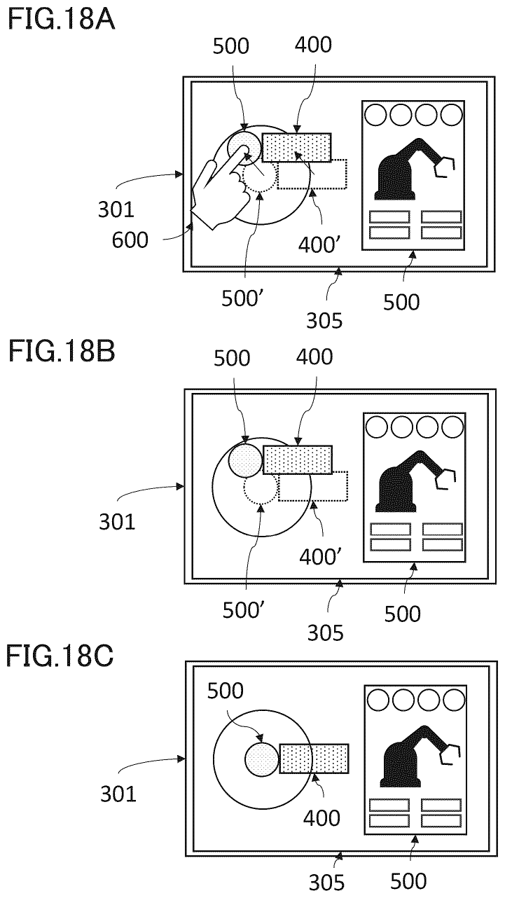

In the present embodiment, in a case where the touch input by the operator has not been performed for a long time, the display state of the enable switch (second image) is automatically returned to the original state. Therefore, for example, there is no need to reset the enable switch (second image) when the operator resumes work after suspension, so that an effect of high operability is achieved. The present embodiment is specifically exemplified by the following description and the like with reference to FIGS. 18A to 18C.

### Eighth Embodiment

An eighth embodiment is the input device according to any one of the first to seventh embodiments, in which in a case where the touch input detection unit detects the touch input operation on the first image, the display control unit is configured to change the display state of the second image to a predetermined display state set in advance.

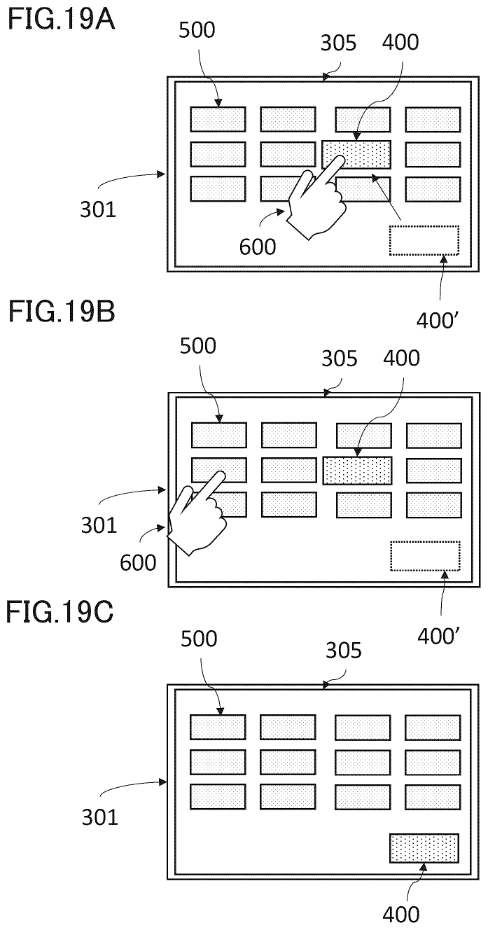

In the present embodiment, for example, in a case where the operator operates the device operation input region (first image) requiring a two-point touch, the display state of the enable switch (second image) can be automatically changed to a predetermined state so as to facilitate the operation. Therefore, the operator can easily perform the two-point touch, so that an effect of preventing an erroneous operation is achieved. The present embodiment is specifically exemplified by the following description and the like with reference to FIGS. 19A to 19C.

### Ninth Embodiment

A ninth embodiment is the input device according to any one of the first to eighth embodiments, in which in a state in which the display control unit displays the first image and the second image so as to overlap each other at an arbitrary position on the display screen, in a case where the touch input detection unit detects the touch input operation on the arbitrary position, the touch input operation on the arbitrary position is treated as the touch input operation on the second image.

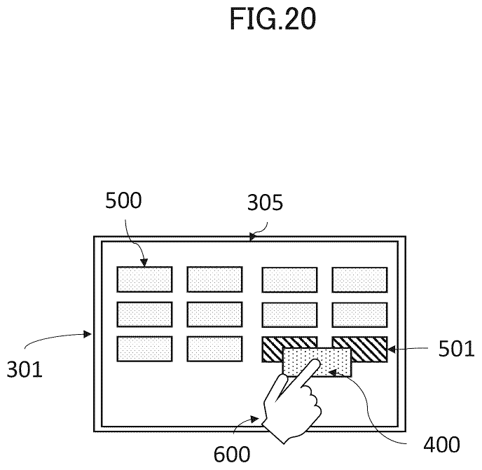

In the present embodiment, when the operation on the device operation input region (first image) displayed so as to overlap the enable switch (second image) is received, it is first determined that the enable switch (second image) is touched. Since the enable switch functions effectively, the operation on the device operation input region is not treated as the direct input on the device operation input region (first image). Therefore, an effect of ensuring safety of the device operation is achieved. The present embodiment will be specifically exemplified by the following description and the like with reference to FIG. 20.

### Tenth Embodiment

A tenth embodiment is the input device according to any one of the first to eighth embodiments, in which in a case where the display state of the second image is changed such that the first image and the second image overlap each other at an arbitrary position on the display screen, the display control unit is configured to move the first image from the arbitrary position such that the first image and the second image do not overlap each other.

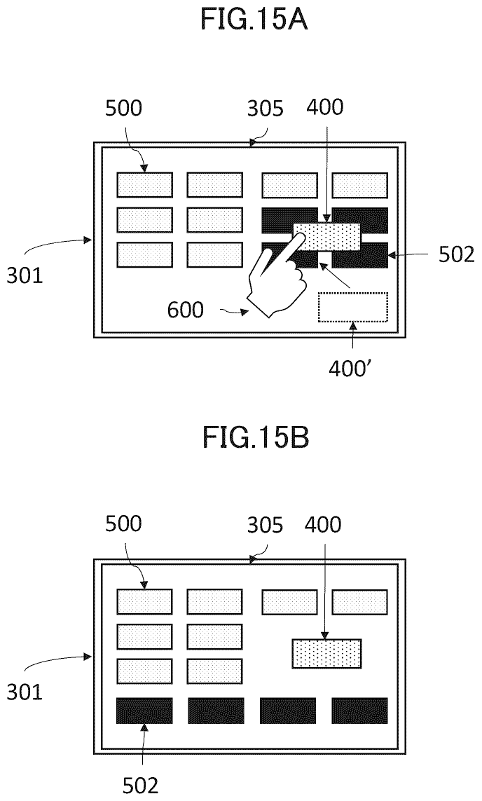

According to the present embodiment, in a case where the display position of the enable switch (second image) is moved, the device operation input region (first image) is automatically moved to a position not overlapping the enable switch (second image). Therefore, an effect of preventing an erroneous touch on the device operation input region (first image) is achieved. The present embodiment is specifically exemplified by the following description and the like with reference to FIGS. 15A and 15B.

### Eleventh Embodiment

An eleventh embodiment is the input device according to any one of the first to eighth embodiments, in which in a case where the display state of the second image is changed such that the first image and the second image overlap each other at an arbitrary position on the display screen, the display control unit is configured to bring a display position of a portion of the first image other than the arbitrary position close to the arbitrary position.

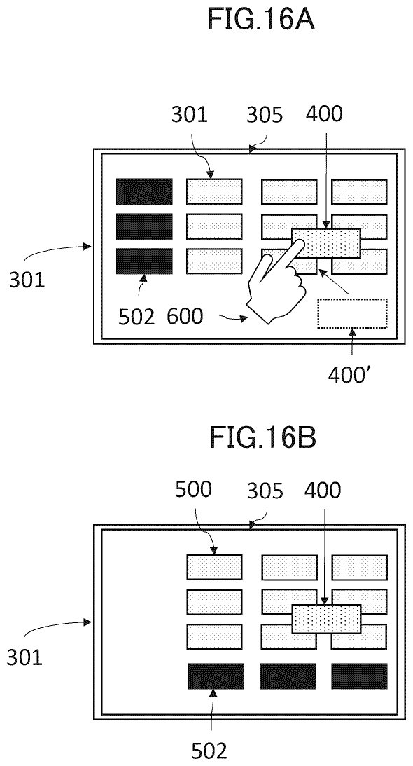

In the present embodiment, a part of the device operation input region (first image) displayed at a distance from the enable switch (second image) is automatically brought close to the enable switch (second image). Therefore, the enable switch (second image) and the device operation input region (first image) are arranged at positions where the operator can simultaneously operate the enable switch (second image) and the device operation input region (first image) with one hand, so that an effect of enhancing operability is achieved. The present embodiment is specifically exemplified by the following description and the like with reference to FIGS. 16A and 16B.

### Twelfth Embodiment

A twelfth embodiment is the input device according to any one of the first to eighth embodiments, in which the display control unit is configured to display the second image in a predetermined region that does not overlap the first image.

In the present embodiment, the enable switch (second image) is displayed in a predetermined region that does not overlap the device operation input region (first image). Therefore, the enable switch (second image) and the device operation input region (first image) are always displayed apart from each other. Therefore, an effect of preventing an erroneous touch on the device operation input region (first image) in a case where the enable switch (second image) is touched is achieved. The present embodiment is specifically exemplified by the following description and the like with reference to FIGS. 10, 11A, 11B, and 47.

### Thirteenth Embodiment

A thirteenth embodiment is the input device according to any one of the first to twelfth embodiments, in which in a case where the touch input operation on the second image is detected, the touch input detection unit is configured to determine that the touch input operation on a predetermined region in the first image is permitted.

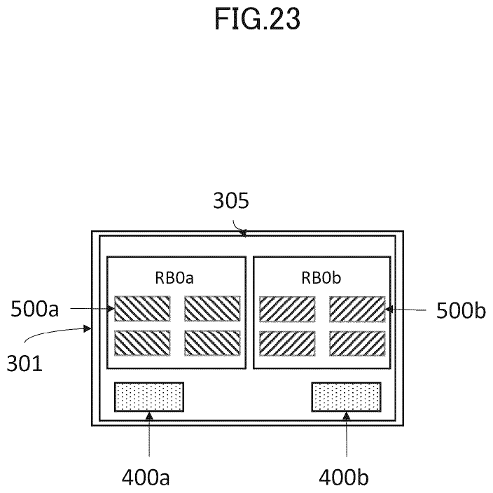

In the present embodiment, for example, in order to enable operation of a plurality of devices, a plurality of sets of the enable switch (second image) and the device operation input region (first image) associated with the respective devices may be displayed on the control panel image. According to the present embodiment, in a case where the touch operation on the enable switch (second image) corresponding to a certain device is performed effectively, only the device operation input region (first image) corresponding to the device can be operated. Therefore, since an erroneous touch on the device operation input region (first image) of a non-corresponding device is not received, an effect of preventing an erroneous operation input is achieved. The present embodiment will be specifically exemplified by the following description and the like with reference to FIG. 23.

### Fourteenth Embodiment

A fourteenth embodiment is the input device according to the thirteenth embodiment, in which the predetermined region is a region having a relatively small distance to the second image in the first image.

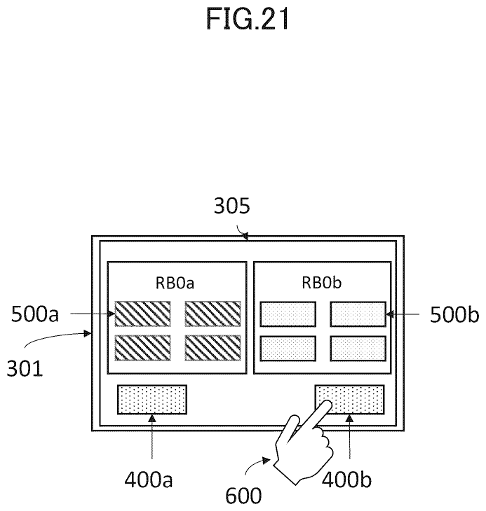

In the present embodiment, only the device operation input region (first image) close to the enable switch (second image) can be operated. Therefore, an effect of preventing an erroneous operation on the device operation input region (first image) far from the enable switch (second image), and enabling the operator to easily operate the device operation input region and the enable switch with one hand is achieved. The present embodiment will be specifically exemplified by the following description and the like with reference to FIG. 21.

### Fifteenth Embodiment

A fifteenth embodiment is the input device according to the thirteenth embodiment, in which the predetermined region is a region having a relatively large distance to the second image in the first image.

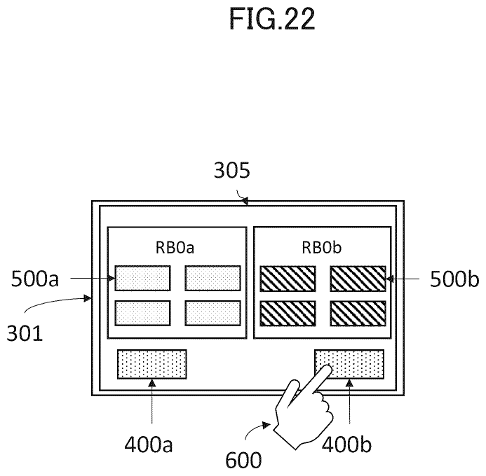

In the present embodiment, only the device operation input region (first image) far from the enable switch (second image) can be operated. Therefore, for example, an effect of preventing an erroneous touch in the vicinity of the enable switch (second image) in a case where operation input requiring a two-point touch is performed is achieved. The present embodiment will be specifically exemplified by the following description and the like with reference to FIG. 22.

### Sixteenth Embodiment

A sixteenth embodiment is the input device according to any one of the thirteenth to fifteenth embodiments, in which the predetermined region is any one of a region in which the information regarding the operation of the device among pieces of the information regarding the device is displayed and a region in which information not related to the operation of the device among the pieces of information regarding the device is displayed.

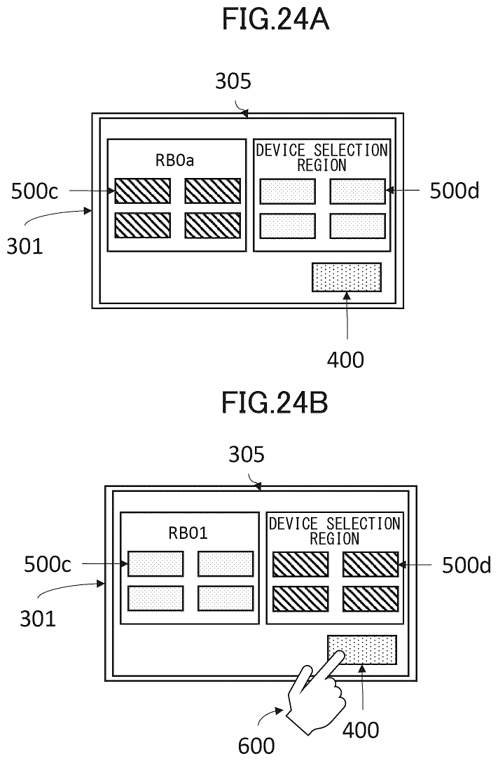

In the present embodiment, in a case where the touch on the enable switch (second image) is detected, only a region related to the operation of the device in the device operation input region (first image) can be operated. Alternatively, in a case where the touch on the enable switch (second image) is detected, only a region not related to the operation of the device in the device operation input region (first image) can be operated. Therefore, the operator can easily perform the touch input according to the purpose in a case where the operator desires to operate the device or desires to perform the input other than the operation, so that an effect of improving operability is achieved. The present embodiment is specifically exemplified by the following description and the like with reference to FIGS. 24A and 24B.

### Seventeenth Embodiment

A seventeenth embodiment is the input device according to any one of the thirteenth to sixteenth embodiments, in which the display control unit is configured to perform display such that the predetermined region and a portion other than the predetermined region in the first image are identifiable.

According to the present embodiment, in a case where the touch on the enable switch (second image) is detected, the operator can easily identify a region capable of receiving the touch input and other regions in the device operation input region (first image), so that an effect of improving operability is achieved. The present embodiment is specifically exemplified by the following description and the like with reference to FIGS. 21, 22, 24A, and 24B.

### Eighteenth Embodiment

An eighteenth embodiment is the input device according to any one of the first to seventeenth embodiments, in which
the second image includes a first portion and a second portion, and
the touch input detection unit is configured to determine that the touch input operation on the first image is permitted in a case where touches made in a predetermined order on the first portion and the second portion are detected.

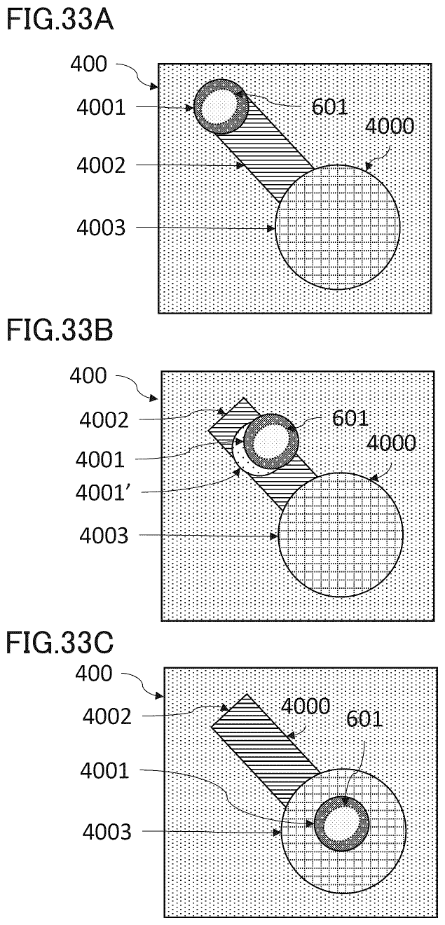

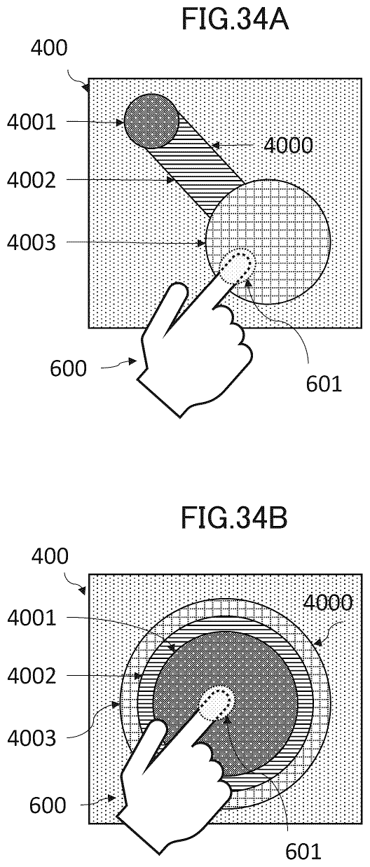

In the present embodiment, in a case where a gesture of touching the first portion and then touching the second portion is detected, it is determined that the touch operation on the enable switch (second image) has been performed. Therefore, an effect of preventing erroneous determination of the touch input performed on the enable switch (second image) is achieved. The present embodiment is specifically exemplified by the following description and the like with reference to FIGS. 33A to 33C, 34A, and 34B.

### Nineteenth Embodiment

A nineteenth embodiment is the input device according to any one of the first to seventeenth embodiments, in which
the second image includes a first portion and a second portion displayed on a part of the first portion in an overlapping manner, and
the touch input detection unit is configured to determine that the touch input operation on the first image is permitted in a case where touches made in a predetermined order on the first portion and the second portion are detected.

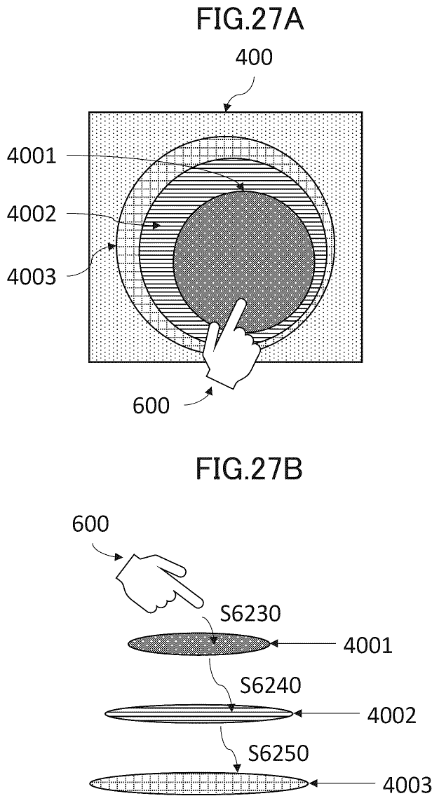

In the present embodiment, the enable switch (second image) in which a plurality of portions overlap each other can be displayed. Therefore, various gestures can be set for the touch input on the enable switch (second image), so that an effect of preventing erroneous determination of the touch input performed on the enable switch (second image) is achieved. The present embodiment is specifically exemplified by the following description and the like with reference to FIGS. 27A and 27B.

### Twentieth Embodiment

A twentieth embodiment is the input device according to the eighteenth embodiment, in which
the second image further includes a third portion connecting the first portion and the second portion, and
the touch input detection unit is configured to determine that the touch input operation on the first image is permitted in a case where a touch moving from the first portion to the second portion via the third portion is detected.

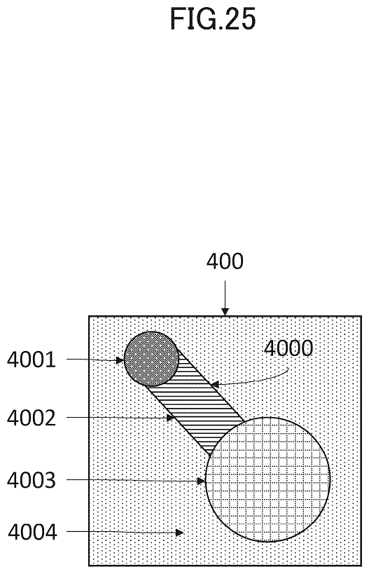

In the present embodiment, the operator needs to perform a predetermined gesture when performing the touch input to the enable switch (second image), so that an effect of preventing erroneous input on the enable switch (second image) or erroneous determination of the touch input is achieved. The present embodiment will be specifically exemplified by the following description and the like with reference to FIG. 25.

### Twenty-First Embodiment

A twenty-first embodiment is the input device according to the eighteenth embodiment, in which the touch input detection unit is configured to detect whether or not the touch on the first portion and the touch on the second portion are made by the same contacting body, and determines that the touch input operation on the first image is permitted in a case where it is detected that the touches are made by the same contacting body.

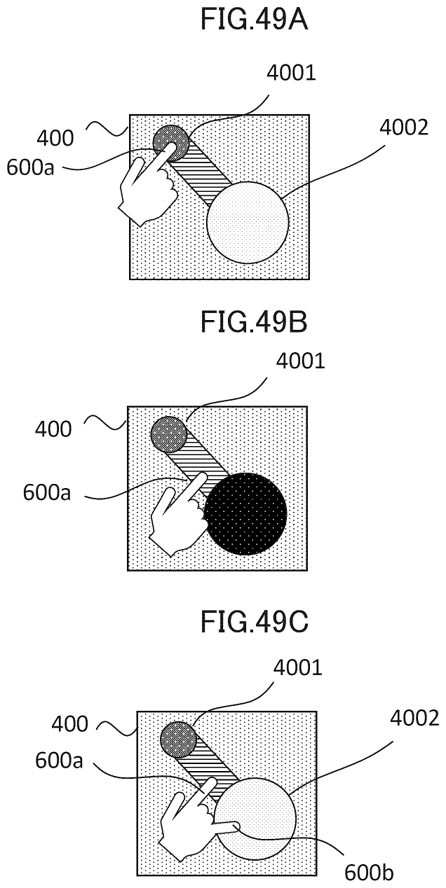

In the present embodiment, a touch operation made by a contacting body other than the contacting body (for example, a finger) operating the enable switch (second image) is not received, so that an effect of preventing erroneous input caused by erroneous touch made by another finger is achieved, for example. The present embodiment is specifically exemplified by the following description and the like with reference to FIGS. 49A to 49C.

### Twenty-Second Embodiment

A twenty-second embodiment is the input device according to the eighteenth embodiment, in which
the second image includes a figure including a first portion and a second portion, and a third portion that does not include the figure, and
in a case where the touch input detection unit detects a touch input operation of moving a touch position with time while touching the third portion, the display control unit is configured to move a display position of the second image so as to follow the movement of the touch position.

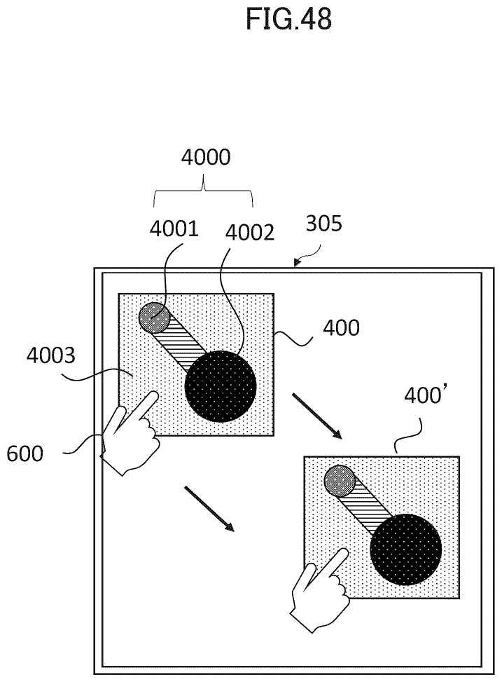

In the present embodiment, the display position of the enable switch (second image) can be changed by a gesture with one contact point (for example, one finger). Therefore, the operator can easily change the display position of the enable switch to a position at which the operator can easily perform the operation input, so that an effect of improving operability is achieved. The present embodiment will be specifically exemplified by the following description and the like with reference to FIG. 48.

### Twenty-Third Embodiment

A twenty-third embodiment is the input device according to any one of the first to seventeenth embodiments, in which
in a case where the touch input detection unit simultaneously detects touches by two or more contacting bodies in the second image, the touch input detection unit is configured to determine whether or not the touches are the touch input operations corresponding to a predetermined gesture based on trajectories of touch positions by the two or more contacting bodies, and
in a case where it is determined that the touches are the touch input operations corresponding to the predetermined gesture, the display control unit is configured to change the display state of the second image to a display state set in association with the predetermined gesture.

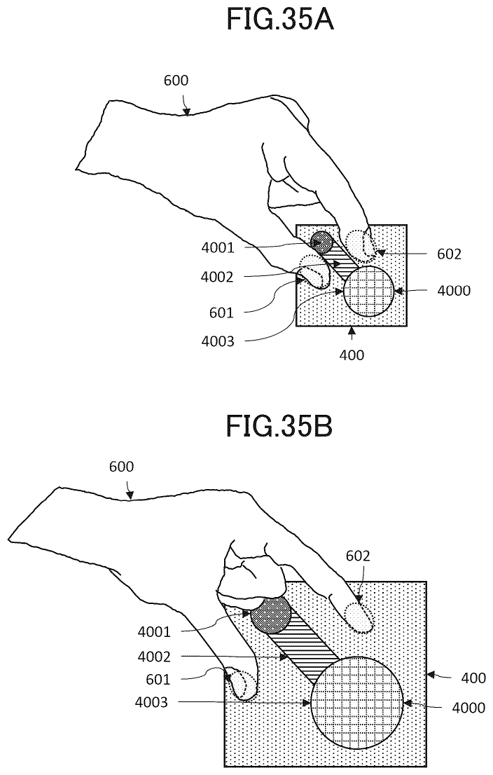

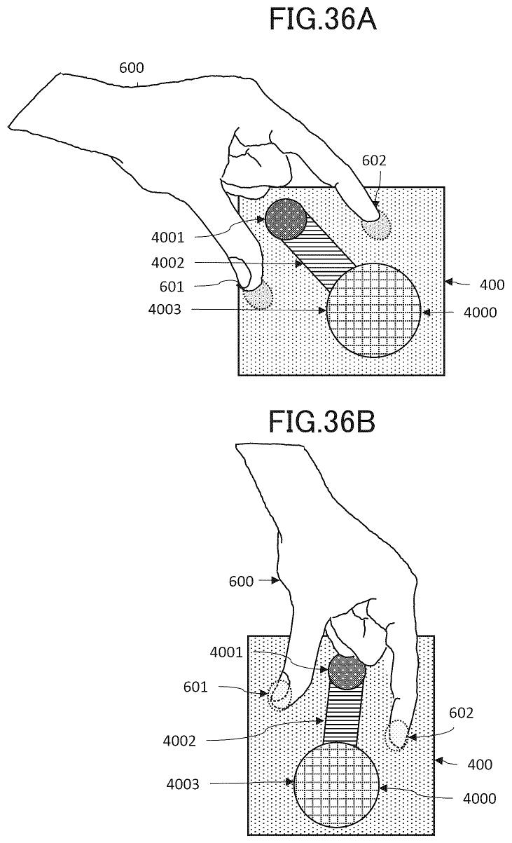

In the present embodiment, the display state of the enable switch (second image) can be easily changed by a gesture using two or more contact points (for example, two or more fingers), so that an effect of improving operability for the operator is achieved. For example, it is possible to easily perform an operation such as increasing a size of the entire enable switch (second image). The present embodiment is specifically exemplified by the following description and the like with reference to FIGS. 35A and 35B and FIGS. 36A and 36B.

### Twenty-Fourth Embodiment

A twenty-fourth embodiment is the input device according to any one of the first to seventeenth embodiments, in which
the second image includes a first portion and a second portion,
in a case where the touch input detection unit simultaneously detects touches by two or more contacting bodies in the first portion, the touch input detection unit is configured to determine whether or not the touches are the touch input operations corresponding to a predetermined gesture based on trajectories of touch positions by the two or more contacting bodies, and
in a case where it is determined that the touches are the touch input operations corresponding to the predetermined gesture, the display control unit is configured to change a display state of the first portion to a display state set in association with the predetermined gesture.

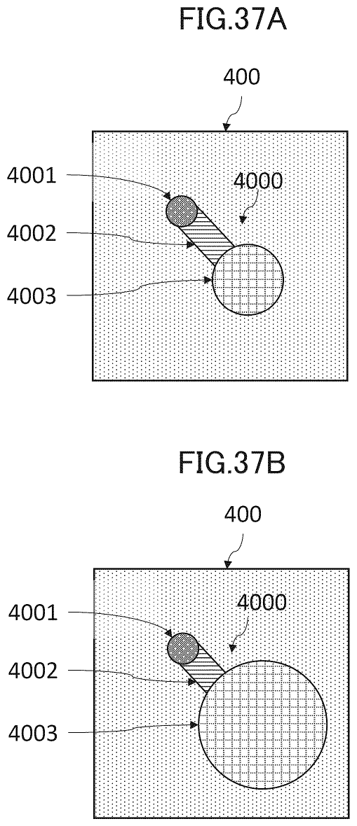

In the present embodiment, the display state of the first portion included in the enable switch (second image) can be changed by a gesture using two or more contact points (for example, two or more fingers), so that an effect of improving operability for the operator is achieved. For example, it is possible to easily perform an operation such as increasing a size of only the first portion in the enable switch (second image) to facilitate the touch operation. The present embodiment is specifically exemplified by the following description and the like with reference to FIGS. 37A and 37B.

### Twenty-Fifth Embodiment

A twenty-fifth embodiment is the input device according to the twenty-third or twenty-fourth embodiment, in which in a case where change amounts of the trajectories of the touch positions by the two or more contacting bodies are equal to or less than a predetermined distance in a predetermined time, the touch input detection unit is configured to determine that the touches do not correspond to the touch input operations corresponding to the predetermined gesture.

In the present embodiment, a possibility of erroneously determining that a gesture has been input in a case where the operator hesitates to perform the gesture and the finger does not move is reduced, so that an effect of improving accuracy and ease of the operation input is achieved. The present embodiment is specifically exemplified by the following description and the like with reference to FIGS. 35A and 35B and FIGS. 36A and 36B.

### Twenty-Sixth Embodiment

A twenty-sixth embodiment is the input device according to the eighteenth embodiment, in which
the second image includes a first portion and a second portion, and
in a case where the touch input detection unit detects that a contacting body touches the second portion and a touch position by the contacting body moves, the display control unit is configured to move a display position of the second image so as to follow the movement of the touch position.

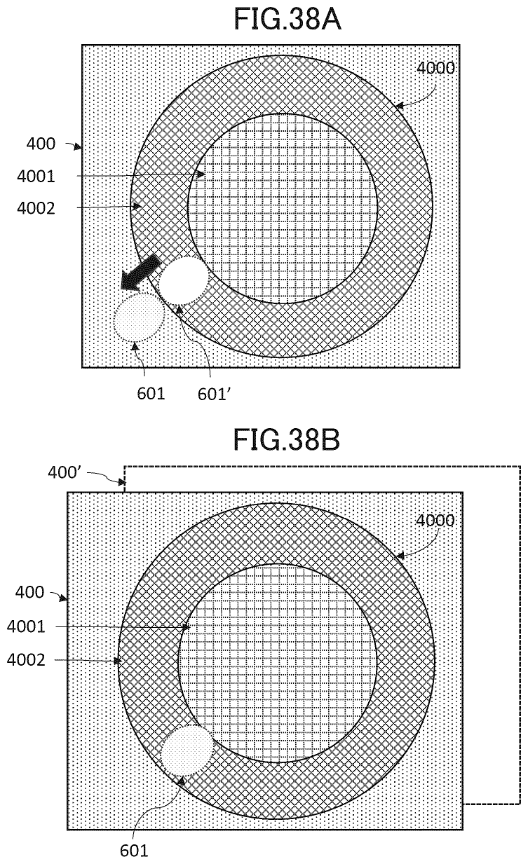

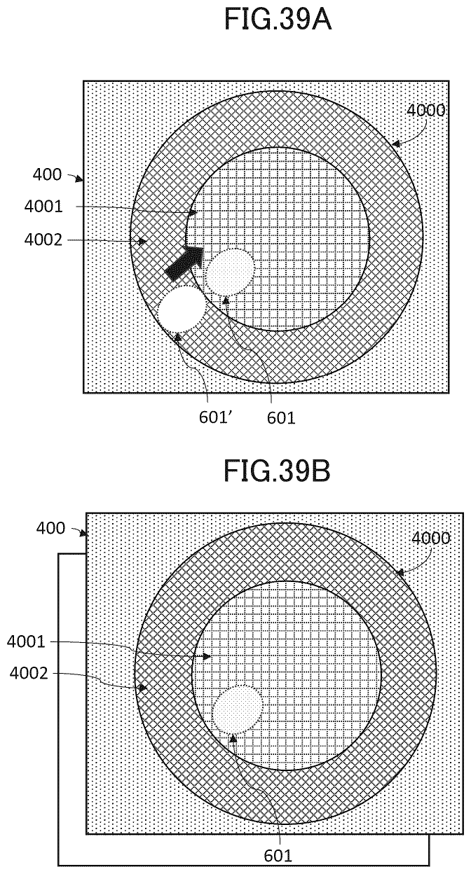

According to the present embodiment, the display position of the enable switch (second image) can be easily changed without interrupting the touch input operation on the enable switch (second image), so that an effect of high operability is achieved. The present embodiment is specifically exemplified by the following description and the like with reference to FIGS. 38A, 38B, 39A, and 39B.

### Twenty-Seventh Embodiment

A twenty-seventh embodiment is the input device according to any one of the first to seventeenth embodiments, in which the second image includes a first portion for displaying information regarding permission of the touch input operation on the first image, and a second portion for displaying information regarding the display state of the second image, and
in a case where the touch input detection unit detects touch input on the second portion, the display control unit is configured to change the display state of the second image according to the detected touch input.

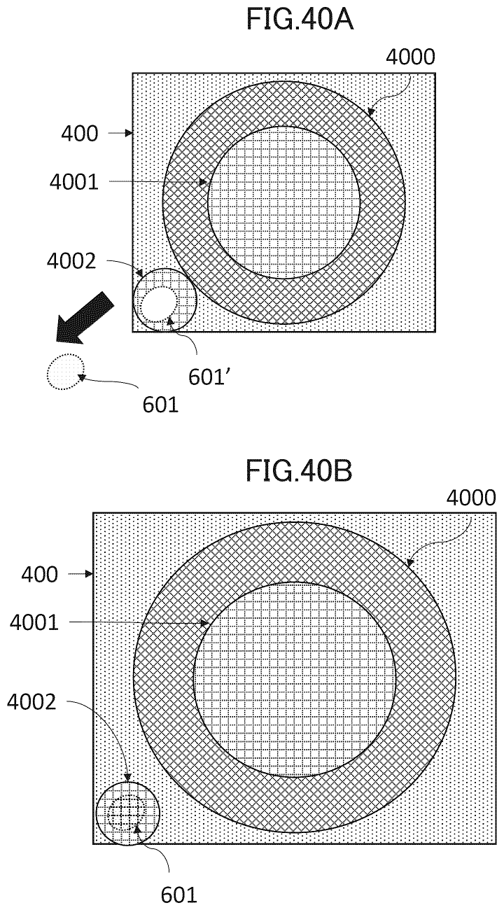

In the present embodiment, the display state (for example, a display position or a display size in the control panel image 305) of the enable switch (second image) can be easily changed by the touch input on the second portion, so that an effect of improving operability is achieved. The present embodiment is specifically exemplified by the following description and the like with reference to FIGS. 40A and 40B.

### Twenty-Eighth Embodiment

A twenty-eighth embodiment is the input device according to any one of the first to seventeenth embodiments, in which the touch input detection unit is configured to determine that the touch input operation on the first image is permitted in a case where a touch on the second image by a contacting body continues for a period longer than a predetermined time.

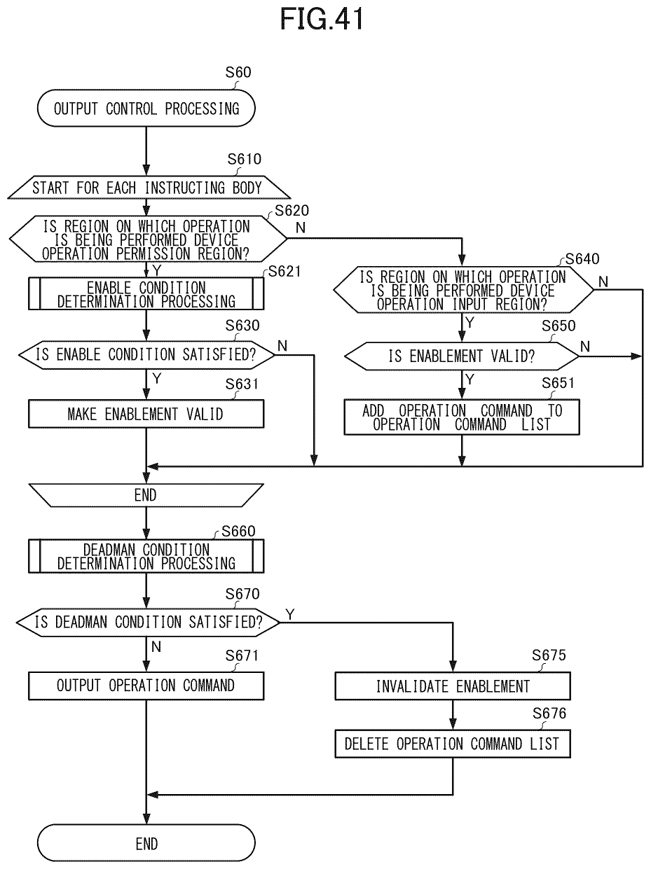

In the present embodiment, in a case where the operator touches the enable switch (second image) for a period longer than the predetermined time, the touch is received as a normal touch input operation. However, for example, in a case where the operator cannot maintain contact with the display screen for a period longer than the predetermined time due to loss of consciousness or the like, the input on the enable switch (second image) can be prevented from being received (deadman function). The deadman function refers to a function of disabling the input in order to prevent the input device from receiving an inappropriate command or the like in a case where an appropriate input operation becomes impossible due to, for example, death or loss of consciousness of the operator, or the operator moves to a position at which the operator cannot operate the input device. In the present embodiment, in a case where the operator is not in a normal state, reception of the input on the device operation input region (first image) can be prevented, so that an effect of preventing occurrence of an accident or the like due to erroneous operation of the device is achieved. The present embodiment is specifically exemplified by the description and the like with reference to S341 of FIG. 8 and FIG. 41.

### Twenty-Ninth Embodiment

A twenty-ninth embodiment is the input device according to any one of the first to seventeenth embodiments, in which the touch input detection unit is configured to determine that the touch input operation on the first image is permitted in a case where a touch position on the second image by a contacting body is changed only by a distance smaller than a predetermined distance over a predetermined time.

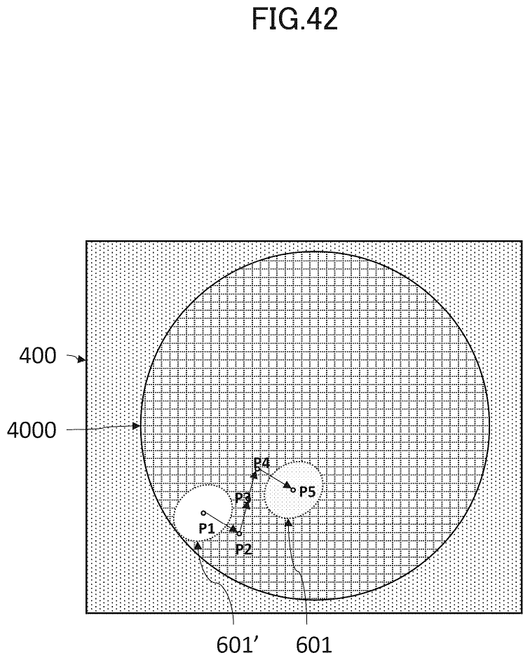

In the present embodiment, in a case where the contacting body touches the enable switch (second image) for a period longer than the predetermined time in a state in which the touch position is in a substantially stationary state, the touch is received as a normal touch input operation. However, for example, in a case where the operator cannot maintain contact in a state in which the touch position is in a substantially stationary state for a period longer than the predetermined time due to loss of consciousness or the like, it is possible not to receive the touch as the input on the enable switch (second image) (deadman function). Therefore, in a case where the operator is not in a normal state, reception of the input on the device operation input region (first image) can be prevented, so that an effect of preventing occurrence of an accident or the like due to erroneous operation of the device is achieved. The present embodiment will be specifically exemplified by the following description and the like with reference to FIG. 42.

### Thirtieth Embodiment

A thirtieth embodiment is the input device according to any one of the first to seventeenth embodiments, in which the touch input detection unit is configured to determine that the touch input operation on the first image is permitted in a case where touches on the second image by a predetermined number of contacting bodies are detected simultaneously.

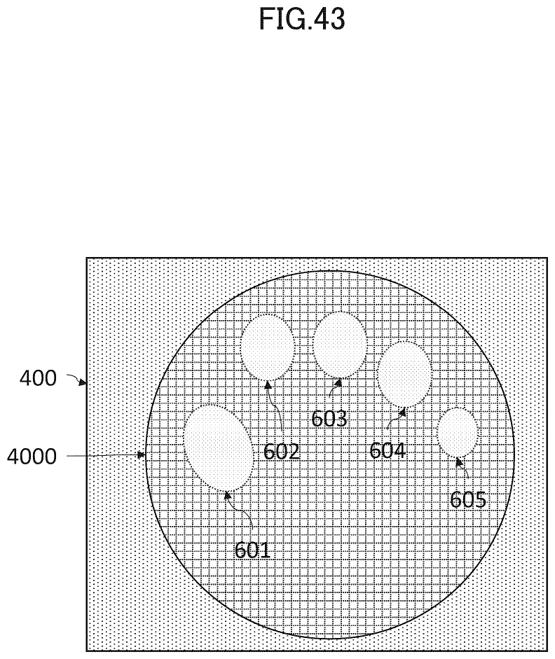

In the present embodiment, in a case where the touches on the enable switch (second image) by a predetermined number of contacting bodies (for example, fingers) are detected simultaneously, it is determined that the touch input operation on the device operation input region (first image) is permitted. For example, since a touching operation with a predetermined number of fingers needs to be consciously performed by the operator, there is a low possibility of accidental erroneous touch. As a result, an effect of improving the accuracy of the touch input is achieved, and such a configuration is also useful as the deadman function. The present embodiment will be specifically exemplified by the following description and the like with reference to FIG. 43.

### Thirty-First Embodiment

A thirty-first embodiment is the input device according to any one of the first to seventeenth embodiments, in which the touch input detection unit is configured to determine that the touch input operation on the first image is permitted in a case where a touch position on the second image by a contacting body moves by a predetermined distance or more in a predetermined time.

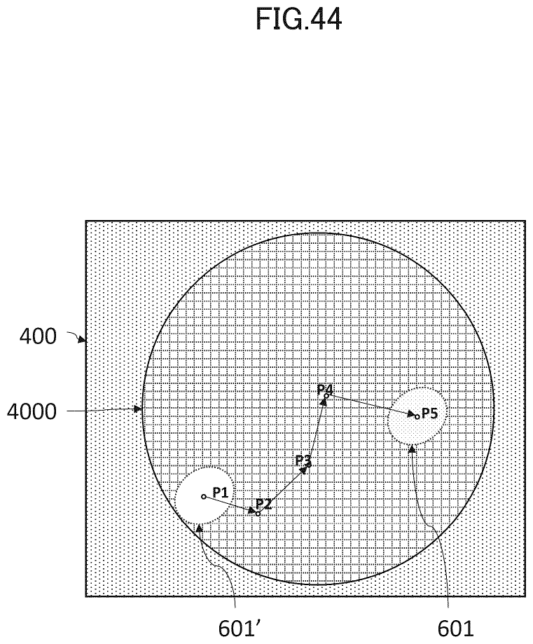

In the present embodiment, in a case where the operator performs a gesture to move the touch position on the enable switch (second image) by a predetermined distance or more in a predetermined time, the gesture is received as the operation input. Since such an operation needs to be consciously performed by the operator, there is a low possibility of accidental erroneous touch. A possibility that erroneous contact by the operator is received as the operation input is reduced, so that an effect of improving accuracy of the touch input is achieved, and such a configuration is also useful as the deadman function. The present embodiment will be specifically exemplified by the following description and the like with reference to FIG. 44.

### Thirty-Second Embodiment

A thirty-second embodiment is the input device according to any one of the first to seventeenth embodiments, in which the touch input detection unit is configured to determine that the touch input operation on the first image is permitted in a case where a trajectory of a touch position on the second image by a contacting body surrounds a predetermined point by a predetermined angle or more.

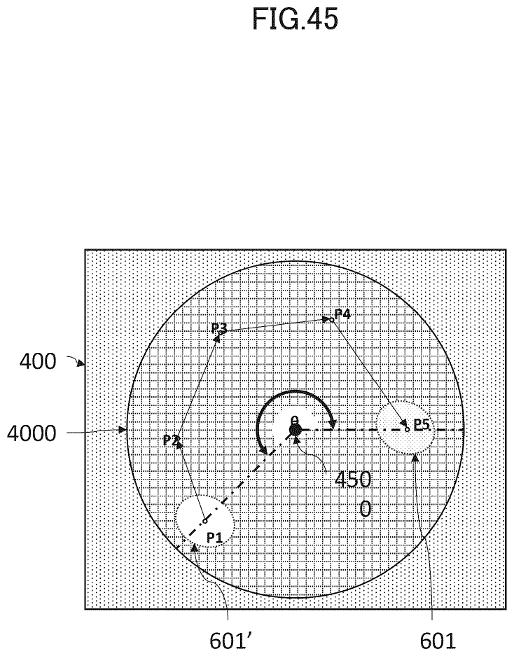

In the present embodiment, in a case where the trajectory of the touch position on the enable switch (second image) by the operator surrounds a predetermined point by a predetermined angle or more, the trajectory is received as the operation input. Since such an operation needs to be consciously performed by the operator, there is a low possibility of accidental erroneous touch. A possibility that erroneous contact by the operator is received as the operation input is reduced, so that accuracy of the touch input is improved, and such a configuration is also useful as the deadman function. The present embodiment will be specifically exemplified by the following description and the like with reference to FIG. 45.

### Example of Control Panel Image

Hereinafter, the above-described embodiments will be specifically described with reference to the drawings illustrating the control panel image 305 displayed on the touch panel 301 of the display unit 300. The following description also includes contents related to a processing procedure performed in step S320, step S341, step S342, and the like of the display control processing S30 described with reference to FIG. 8.

FIG. 10 is a diagram illustrating an example of a configuration of the control panel image 305 displayed on the touch panel 301 of the display unit 300 in the device operation stage (device operation mode), which relates to the first, second, and twelfth embodiments, and the like. In the control panel image 305, the device operation permission region 400 (second image) and the device operation input region 500 (first image) are displayed. The control panel image 305 illustrated in FIG. 10 is, for example, an image displayed on the touch panel 301 in an initial state in which the device operation mode is started. In this example, twelve elements (for example, operation switches) related to the operation of the device are displayed in the device operation input region 500. In the device operation permission region 400, the enable switch for permitting reception of the touch input on the device operation input region 500 is displayed.

FIGS. 11A and 11B are diagrams illustrating an example in which a display state of the device operation permission region 400 is changed when the operator performs a predetermined gesture by the touch input using a contacting body 600 (for example, a finger), which relates to the first, second, and twelfth embodiments, and the like. Changing the display state includes, for example, moving the display position, changing the size, the shape, or the color, changing an orientation, changing from a non-display state to a display state, changing from the display state to the non-display state, and the like.

Table 1 illustrated in FIG. 46 illustrates various gestures and display state change contents set in association with the gestures. For example, in a case where the operator touches the device operation permission region 400 with one finger as illustrated in FIG. 11A and moves the finger to a position in FIG. 11B while maintaining contact with the device operation permission region 400, the gesture determination unit 322 (FIG. 2) determines that the gesture is a drag gesture. In step S341 in FIG. 8, the display control unit 324 that has received the determination result changes the display state of the device operation permission region 400. That is, as illustrated in FIG. 11B, the display position of the device operation permission region 400 is moved following the touch position.

In the example of FIG. 11B, the device operation permission region 400 (second image) is moved to a position at which the device operation input region 500 (first image) is not displayed. However, the device operation permission region 400 (second image) may also be moved to a position at which the device operation input region 500 (first image) is displayed. If the device operation permission region 400 and the device operation input region 500 are displayed so as not to overlap each other as in the former case, a possibility of erroneously touching the device operation input region 500 when touching the device operation permission region 400 is reduced, so that the operator can perform the touch input operation with a sense of security. In the latter case where the display ranges of the device operation permission region 400 and the device operation input region 500 overlap each other, a skilled operator can perform the touch input on both the device operation permission region 400 and the device operation input region 500 with one hand, for example, and thus operability is improved.

FIG. 12 illustrates an example of a method of easily designating an arbitrary position as a movement destination of the device operation permission region 400 (second image), which relates to the third embodiment and the like. When the device operation permission region 400 is displayed at a display position 400′, the operator touches an arbitrary position without touching the device operation permission region 400 with the contacting body 600 (for example, a finger). When the touch input detection unit detects the touch input, the display control unit 324 moves the display position of the device operation permission region 400 to the touched arbitrary position.

In step S320 in FIG. 8, the display control unit 324 determines that the touch on the arbitrary position is an operation of changing the display state of the device operation permission region 400. Since the touch is not a touch on the device operation permission region 400 (second image), a negative determination (NO) is made in both steps S330 and S340, and the processing proceeds to step S341. In step S341, the display control unit 324 changes the display position of the device operation permission region 400 to the designated arbitrary position.

In a case where the touched arbitrary position is a position at which the device operation input region 500 (first image) is displayed, the display position of the device operation permission region 400 (second image) may be moved so as to approach the position without overlapping the device operation input region 500 (first image). For example, in a case where the operator is not a skilled operator, and a possibility of erroneous operation thus increases when the device operation permission region 400 and the device operation input region 500 are displayed so as to overlap each other, a method of moving the device operation permission region 400 so as to approach the device operation input region 500 without overlapping the device operation input region 500 is a suitable display method.

According to the method of FIG. 12, it is not necessary to perform a gesture as in the method of FIGS. 11A and 11B, and thus, the display position of the device operation permission region 400 (second image) can be moved by a simple touch operation.

FIGS. 13A and 13B illustrate an example of a method of moving the device operation permission region 400 (second image) following the touch operation on the device operation input region 500 (first image), which relates to the fourth embodiment and the like. In this example, in a case where the operator performs the drag gesture on the device operation input region 500 (first image) by the touch input using the contacting body 600 (for example, a finger), the display position of the device operation permission region 400 is changed following the change of a display position of the device operation input region 500. As illustrated in FIG. 13A, it is assumed that the device operation permission region 400 (second image) and the device operation input region 500 (first image) are displayed, and the operator touches the device operation input region 500 with the contacting body 600 (for example, a finger). Then, as illustrated in FIG. 13B, when the touch input detection unit detects that the drag gesture has been performed, the display control unit 324 moves the display position of the device operation input region 500 and moves the display position of the device operation permission region 400 in conjunction with the movement of the display position of the device operation input region 500. That is, the display position of the device operation input region 500 is moved while maintaining a relative positional relationship between the device operation permission region 400 and the device operation input region 500. FIG. 13B schematically illustrates that the device operation input region 500 was present at a display position 500′, and the device operation permission region 400 was present at the display position 400′ when the operator starts touching the device operation input region 500 with the contacting body 600 (for example, the finger).

In this example, in step S320 in FIG. 8, the display control unit 324 determines that dragging of the device operation input region 500 is an operation of changing the display state of the device operation permission region 400. Next, a negative determination (NO) is made in both step S330 and step S340, and the processing proceeds to step S341. In step S341, the display control unit 324 changes the display position of the device operation permission region 400 following the movement of the device operation input region 500.

For example, in a case where the device operation input region 500 (first image) is the operation object including the moving body such as the stick or the slide bar, the device operation permission region 400 is moved following the device operation input region 500, and thus, the relative positional relationship therebetween is not changed. For this reason, when performing subsequent touch input, the operator can easily perform the operation, and convenience is improved.

FIGS. 14A to 14C are diagrams illustrating a method of switching between non-display and display of the device operation permission region 400 as an example of a method of switching the display state of the device operation permission region 400 (second image), which relates to the fifth embodiment and the like. FIG. 14A illustrates a state in which the device operation input region 500 is displayed and the device operation permission region 400 is not displayed on the control panel image 305 of the touch panel 301. As illustrated in FIG. 14B, when the touch input detection unit detects a touch performed on a position at which the device operation input region 500 is not displayed, the display control unit 324 displays the device operation permission region 400 at the position at which the touch is detected as illustrated in FIG. 14C.

The switching between display and non-display of the device operation permission region 400 may be performed when a predetermined gesture is detected at a position at which neither the device operation input region 500 nor the device operation permission region 400 is displayed in the screen displayed on the touch panel 301. For example, any one of the gestures illustrated in Table 1 of FIG. 45 may be assigned as the predetermined gesture.

When the predetermined gesture is detected in a region excluding the device operation input region 500 and the device operation permission region 400, the display control unit 324 determines in step S320 in FIG. 8 that the predetermined gesture is the operation of changing the display state of the device operation permission region 400 (that is, YES).

Since a negative determination (NO) is made in subsequent step S330 and a negative determination (NO) is made in step S340, the processing proceeds to step S341. Next, in step S341, the display control unit 324 changes the display state to the non-display state in a case where the device operation permission region 400 is displayed, and changes the display state to the display state in a case where the device operation permission region 400 is not displayed. In a case where the display state is changed so as to the device operation permission region 400 is displayed, the device operation permission region 400 may be displayed at a position at which the predetermined gesture is detected, or may be displayed at a predetermined position.

The method of switching between non-display and display of the device operation permission region 400 is not limited to the above-described example. For example, when only an operation button that may directly receive the touch input because the operation button has no influence on safety of the device is displayed in the device operation input region 500, the display control unit 324 may perform control so as not to display the device operation permission region 400. For example, when displaying, in the device operation input region 500, an operation button that always has to be operated through the device operation permission region 400 because the operation button has an influence on the safety of the device, the display control unit 324 may perform control to display the device operation permission region 400. For example, when the input is performed on the operation button that does not have an influence on the safety of the device, a preliminary operation on the device operation permission region 400 is unnecessary, and thus the operability for the operator is improved.

FIGS. 15A and 15B are diagrams illustrating a method of rearranging a component of the device operation input region 500 and displaying the component so as not to overlap the device operation permission region 400 in a case where the device operation permission region 400 is moved to a position overlapping the display range of the device operation input region 500, which relates to the tenth embodiment and the like.

FIG. 15A illustrates a state in which the display range of the device operation permission region 400 overlaps a part of the device operation input region 500 in a case where the operator moves the device operation permission region 400 from the display position 400′ by the touch operation using the contacting body 600 (for example, a finger). When the touch input operation of moving the device operation permission region 400 is performed in this manner, the display control unit 324 moves, to a position not overlapping the device operation permission region 400, a component 502 of the device operation input region 500 positioned at a position to which the device operation permission region 400 has been moved. FIG. 15B illustrates the control panel image 305 in which the overlap between the device operation permission region 400 and the device operation input region 500 is eliminated as a result of the rearrangement of the display position of the component 502.

In step S342 in FIG. 8, the display control unit 324 selects a movement destination of the component 502 positioned at a position at which the display range overlaps the device operation permission region 400 from among regions that do not overlap the device operation permission region 400 in an empty region of the control panel image 305 and rearranges the component 502. In a case where there is no empty space, the rearrangement does not have to be performed.

It may be difficult for the operator to perform accurate touch input depending on how the device operation permission region 400 and the device operation input region 500 overlap each other. If the operator has to manually move the device operation permission region 400 to a position not overlapping the device operation input region 500 in order to facilitate the touch input, the touch input operation becomes complicated. On the other hand, according to the above-described method, the display control unit 324 automatically moves the device operation input region 500 to a position at which the operation is easy and displays the device operation input region 500 at the position, the operability for the operator is improved.

FIGS. 16A and 16B are diagrams illustrating a method of rearranging the component 502 of the device operation input region 500 (first image) and displaying the rearranged component 502 so as to be close to the device operation permission region 400 (second image) in a case where the device operation permission region 400 is moved to a position overlapping the display range of the device operation input region 500, which relates to the eleventh embodiment and the like.

FIG. 16A illustrates a state in which the display range of the device operation permission region 400 partially overlaps the device operation input region 500 in a case where the operator moves the device operation permission region 400 from the display position 400′ by the touch operation using the contacting body 600 (for example, a finger). When the touch input for moving the device operation permission region 400 is performed in this manner, the display control unit 324 moves the component 502 of the device operation input region 500 positioned at a position far from the moved device operation permission region 400 to a position close to the device operation permission region 400. FIG. 16B illustrates the control panel image 305 in which the device operation permission region 400 and the device operation input region 500 are displayed close to each other, which enables easy operation, as a result of the rearrangement of the display position of the component 502.

In step S342 in FIG. 8, the display control unit 324 selects a movement destination of the component 502 of the device operation input region 500 arranged at a position far from the device operation permission region 400 from among regions that do not overlap the device operation permission region 400 in the empty region of the control panel image 305 and rearranges the component 502. In a case where there is no empty space, the rearrangement does not have to be performed. As a result of bringing the component 502 of the device operation input region 500 positioned at a position far from the device operation permission region 400 close to the device operation permission region 400, for example, the operator can easily perform the touch operation on both the device operation permission region 400 and the component 502 with one hand, so that the operability is improved.

FIGS. 17A to 17C are diagrams illustrating a method of changing the display state of the device operation permission region 400 from the initial state and then easily returning the display state to the initial state, which relates to the sixth embodiment and the like.

FIG. 17A illustrates a state in which the operator moves the device operation permission region 400 displayed at the display position 400′ by the touch operation using the contacting body 600 (for example, a finger). When the display position of the device operation permission region 400 is moved, the display control unit 324 displays a mark indicating the display position 400′ before the movement or a reset button on the control panel image 305.

FIG. 17B illustrates a state in which the operator touches the mark or the reset button with the contacting body 600 (for example, a finger). FIG. 17C illustrates a state in which the display state is changed by the display control unit 324 so as to display the device operation permission region 400 at an original position as a result of the touch input detection unit detecting the touch.

In step S350 in FIG. 8, the display control unit 324 determines that a reset condition for the display state of the device operation permission region 400 is satisfied (YES) by the touch operation in FIG. 17B. Then, in step S351, the display control unit 324 resets the display state of the device operation permission region 400. At this time, the display control unit 324 may also reset the display state of the device operation input region 500. In addition, the display control unit 324 may display information indicating that a reset operation is performed on the control panel image 305. Since the display state of the device operation permission region 400 can be reset by a simple operation, the operability for the operator is improved.

FIGS. 18A to 18C are diagrams illustrating a method of automatically returning the display state to a state before the change in a case where the touch input operation is not performed for a predetermined time on either the device operation permission region 400 or the device operation input region 500 after the operation of changing the display state is performed, which relates to the seventh embodiment and the like.

FIG. 18A illustrates a state in which the operator collectively moves the device operation permission region 400 displayed at the display position 400′ and the device operation input region 500 displayed at the display position 500′ by the touch operation using the contacting body 600 (for example, a finger). FIG. 18B illustrates a state in which the contacting body 600 is then separated from the display screen and no touch operation is performed. FIG. 18C illustrates a state in which, in a case where a time during which no touch operation is performed exceeds a predetermined time, the display control unit 324 changes the display state so as to display the device operation permission region 400 at the original display position 400′. At this time, the display control unit 324 may change the display state so as to display the device operation input region 500 at the original display position 500′.

In step S350 in FIG. 8, the display control unit 324 determines that the reset condition is satisfied (YES) based on the fact that no touch operation is performed on either the device operation permission region 400 or the device operation input region 500. Then, in step S351, the display control unit 324 resets the display state of the device operation permission region 400. At this time, the display control unit 324 may also reset the display state of the device operation input region 500. In addition, the display control unit 324 may display information indicating that a reset operation is performed on the control panel image 305. Since the display state of the device operation permission region 400 can be automatically reset, the operability for the operator is improved.

FIGS. 19A to 19C are diagrams illustrating a method of automatically returning the display state of the device operation permission region 400 to a state before the change in a case where the touch input operation is performed on the device operation input region 500 after the operation of changing the display state is performed, which relates to the eighth embodiment and the like.

FIG. 19A illustrates a state in which the operator moves the device operation permission region 400 displayed at the display position 400′ by the touch operation using the contacting body 600 (for example, a finger). FIG. 19B illustrates a state in which the operator performs the operation on the device operation input region 500 by the touch operation using the contacting body 600 (for example, a finger). FIG. 19C illustrates a state in which, in a case where the operation is performed on the device operation input region 500 as illustrated in FIG. 19B, the display control unit 324 automatically returns the display state of the device operation permission region 400 to the state before the movement.

In step S350 in FIG. 8, the display control unit 324 determines that the reset condition is satisfied (YES) based on the fact that the touch input operation is performed on the device operation input region 500. Then, in step S351, the display control unit 324 resets the display state of the device operation permission region 400. At this time, the display control unit 324 may also reset the display state of the device operation input region 500. In addition, the display control unit 324 may display information indicating that a reset operation is performed on the control panel image 305. Furthermore, the display control unit 324 may move the device operation permission region 400 to a predetermined position different from the original display position 400′. Since the display state can be automatically reset, the operability for the operator is improved.

FIG. 20 is a diagram illustrating a state in which, in a case where at least a part of the display region of the device operation permission region 400 and at least a part of the display region of the device operation input region 500 overlap each other, the touch operation performed on an overlapping portion is received as the input on the device operation permission region 400, which relates to the ninth embodiment and the like.

That is, in a region where the device operation permission region 400 and the display of the device operation input region 500 are displayed so as to overlap each other, the touch input on the device operation permission region 400 is received, and the touch input on the device operation input region 500 is not received. In the example of FIG. 20, some components 501 of the device operation input region 500 overlap the device operation permission region 400, but a portion where the components 501 are displayed is treated as a touch input disabled region that does not receive the touch input. In a case where the operator touches the device operation permission region 400 by using the contacting body 600 (for example, a finger), the touch is treated as the touch input on the device operation permission region 400, and is not received as the touch input on the component 501.

In step S630 in FIG. 9, the output control unit 331 determines whether or not the enable condition is satisfied for each component of the device operation input region 500. At this time, it is determined that only the component of the device operation input region 500 with which the display range of the device operation permission region 400 does not overlap satisfies the enable condition. In other words, the output control unit 331 does not output the operation command even in a case where the operator touches the touch input disabled region whose display range overlaps the device operation permission region 400. In a case where at least a part of the display region of the device operation permission region 400 and at least a part of the display region of the device operation input region 500 are displayed so as to overlap each other, there is a high possibility that an erroneous touch on the device operation input region 500 occurs in the vicinity of the overlapping position. In this example, control is performed so as not to receive the touch input on the component 501 arranged in the vicinity of the overlapping position in the device operation input region 500, and thus, an erroneous touch input operation is prevented from being received, and accuracy of the touch input and the operability are improved.

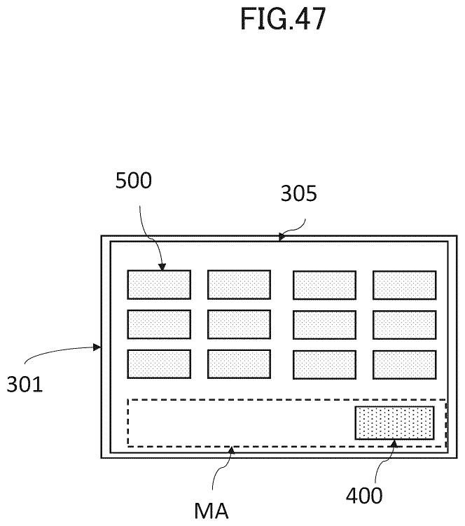

FIG. 47 is a diagram illustrating a method of limiting a range in which the device operation permission region 400 is movable by the touch input operation to a predetermined region that does not overlap the device operation input region 500, which relates to the twelfth embodiment and the like together with FIGS. 10, 11A, 11B, and the like. As illustrated in FIG. 47, the display control unit 324 sets a predetermined region MA in which the device operation permission region 400 is movable. In other words, the predetermined region MA in which the device operation permission region 400 can be displayed is set, and the display of the device operation permission region 400 is prohibited in a region excluding the predetermined region MA. The predetermined region MA is set including the current display position of the device operation permission region 400, and is set so as not to overlap at least the device operation input region 500 to prevent an erroneous touch on the device operation input region 500 from occurring when the touch input on the device operation permission region 400 is performed. In order to reduce a possibility of the erroneous touch, the predetermined region MA may be set so as to be separated from the device operation input region 500 by a predetermined distance.

For example, even in a case where the operator performs a gesture of dragging the device operation permission region 400 to a position overlapping the device operation input region 500 by the touch operation using the contacting body 600 (for example, a finger), the display control unit 324 moves the device operation permission region 400 within the predetermined region MA. When the operator moves the display position of the device operation permission region 400, a burden related to the accuracy of the gesture by the touch input is reduced, and the operability is improved.

FIG. 23 illustrates an example in which a set of the device operation permission region and the device operation input region associated with each device is displayed to enable operation of a plurality of devices, for example, which relates to the thirteenth embodiment and the like. In the example of FIG. 23, a set of a device operation permission region 400a and a device operation input region 500a related to operation of a device RB0a and a set of a device operation permission region 400b and a device operation input region 500b related to operation of a device RB0b are displayed on the control panel image 305. In this example, a set of the device operation permission region and the device operation input region is displayed for each of two devices, but the number of displayed sets is not limited to two.

In step S630 in FIG. 9, the output control unit 331 makes the enablement for only the device operation input region 500b corresponding to the device RB0b valid by operating the device operation permission region 400b corresponding to the device RB0b. The set of the device operation permission region and the device operation input region can be set by the operator in the editing stage (editing mode) and stored in the storage unit 310 (FIG. 2), for example. Alternatively, when an operation of bringing a display position of a certain device operation permission region close to a display position of a certain device operation input region is performed, the device operation permission region and the device operation input region may be automatically registered as a set.

In a case where there is a device operation input region related to operation of a plurality of devices, there is a possibility that another device that is not intended to be operated is erroneously operated. However, according to the present embodiment, in a case where a touch operation on a device operation permission region corresponding to a certain device is valid, only input on the device operation input region corresponding to the device is enabled. As described above, since it is possible to prevent an erroneous operation of a device that is not intended to be operated, an effect of improving the accuracy of the input operation is achieved.

FIG. 21 illustrates a case where a device operation permission region and a device operation input region displayed at relatively close positions form a set when a plurality of device operation permission regions and a plurality of device operation input regions are displayed as in the thirteenth embodiment, which relates to the fourteenth embodiment, the seventeenth embodiment, and the like. In the example of FIG. 21, the device operation permission region 400a forms a set with the device operation input region 500a positioned at a position relatively closer than the device operation input region 500b. The device operation permission region 400b forms a set with the device operation input region 500b positioned at a position relatively closer than the device operation input region 500a. Therefore, in a case where the touch operation is performed on the device operation permission region 400b as illustrated in FIG. 21, the touch input on the device operation input region 500b can be received. An erroneous operation on a device operation input region positioned far from the selected device operation permission region is prevented, and an effect of enabling the operator to easily operate with one hand is achieved.

As illustrated in FIG. 21, if the display state (for example, the color, a luminance, or a texture) of the device operation input region that can receive the input is changed, the operator can easily visually recognize the change and easily perform the operation input, so that the operability is improved. Alternatively, the display state (for example, the color, the luminance, or the texture) of the device operation input region that cannot receive the input may be changed. The set of the device operation permission region and the device operation input region can be set by the operator in the editing stage (editing mode) and stored in the storage unit 310 (FIG. 2), for example.

In step S630 in FIG. 8, the output control unit 331 determines whether or not the enable condition is satisfied for each device operation input region. At this time, in the example of FIG. 21, it is determined that only the device operation input region 500b satisfies the enable condition. Next, in step S650, the output control unit 331 determines whether or not the enablement for the device operation input region on which the touch operation has been performed is valid.

A holding position of the control panel may be a lateral surface of the control panel instead of a back surface of the control panel depending on a posture in which the operator holds the control panel. Furthermore, in a case where a hand holding the control panel is in a positional relationship of touching the touch panel 301, there is a possibility that the hand comes into contact with the device operation input region in a process of picking up or re-grasping the control panel and erroneously operates the device. In the example of FIG. 21, by disabling the operation on a device operation input region displayed at a position far from the touched device operation permission region, it is possible to prevent an erroneous operation on the device operation input region by the hand holding the control panel.

FIG. 22 illustrates a case where a device operation permission region and a device operation input region displayed at relatively far positions form a set when a plurality of device operation permission regions and a plurality of device operation input regions are displayed as in the thirteenth embodiment, which relates to the fifteenth embodiment, the seventeenth embodiment, and the like. In the example of FIG. 22, the device operation permission region 400a forms a set with the device operation input region 500b positioned relatively farther than the device operation input region 500a. The device operation permission region 400b forms a set with the device operation input region 500a positioned at a position relatively farther than the device operation input region 500b. Therefore, in a case where the touch operation is performed on the device operation permission region 400b as illustrated in FIG. 22, the touch input on the device operation input region 500a can be received. For example, in a case where operation input requiring a two-point touch is performed, an effect of preventing an erroneous operation is achieved.

As illustrated in FIG. 22, if the display state (for example, the color, the luminance, or the texture) of the device operation input region that can receive the input is changed, the operator can easily visually recognize the change and easily perform the operation input, so that the operability is improved. Alternatively, the display state (for example, the color, the luminance, or the texture) of the device operation input region that cannot receive the input may be changed. The set of the device operation permission region and the device operation input region can be set by the operator in the editing stage (editing mode) and stored in the storage unit 310 (FIG. 2), for example.

In step S630 in FIG. 8, the output control unit 331 determines whether or not the enable condition is satisfied for each device operation input region 500. At this time, in the example of FIG. 22, it is determined that only the device operation input region 500a satisfies the enable condition. Next, in step S650, the output control unit 331 determines whether or not the enablement for the device operation input region on which the touch operation has been performed is valid.

FIGS. 24A and 24B relate to the sixteenth embodiment, the seventeenth embodiment, and the like. The device operation input region of the control panel image 305 can include a region in which the information related to the operation of the device is displayed and a region in which the information that is not related to the operation of the device is displayed. For example, in a case where the display screen is configured such that the operation information can be input for a plurality of devices, a device selection region for selecting a device for which the operation information is to be input and a region (for example, the operation button) for inputting the operation information to the selected device can be displayed in the device operation input region. For example, when the region for inputting the operation information is erroneously touched while selecting the device, there is a possibility that erroneous operation information is input and the device operates in an uncontrolled manner. In addition, when the device selection region is erroneously touched while inputting the operation information for a certain device, the screen is switched to a screen for inputting the operation information for another device, and the input for the device to be operated is interrupted. In particular, in a case where the touch panel capable of detecting simultaneous input (multi-touch) on a plurality of points by a plurality of contacting bodies is used, such erroneous input is likely to become apparent.

Therefore, in the present embodiment, for example, when the device is selected, only the device selection region receives the touch input, and when the operation information is input, only the region in which the information related to the operation of the device is displayed receives the touch input.

FIG. 24A is a diagram illustrating an example in which, when a touch input operation on the device operation permission region 400 is not performed, a device operation input region 500c in which information related to device operation is displayed does not receive the touch input, and only a device selection region 500d receives the touch input. If a display state (for example, the color, the luminance, or the texture) of the device selection region 500d that receives the touch input is changed, the operator can visually recognize the change and easily perform the operation input, so that the operability is improved. Alternatively, a display state (for example, the color, the luminance, or the texture) of the device operation input region 500c that cannot receive the input may be changed.

FIG. 24B is a diagram illustrating an example in which, when the touch input operation is performed on the device operation permission region 400, only the device operation input region 500c in which the information related to the device operation is displayed receives the touch input, and the device selection region 500d does not receive the touch input. If the display state (for example, the color, the luminance, or the texture) of the device operation input region 500c that receives the touch input is changed, the operator can visually recognize the change and easily perform the operation input, so that the operability is improved. Alternatively, the display state (for example, the color, the luminance, or the texture) of the device selection region 500d that cannot receive the input may be changed. The output control unit 331 determines the touch input on the device operation permission region 400 in step S620 in FIG. 9, and enables the operation only on the region that receives the touch input in step S630.

FIG. 25 relates to the eighteenth embodiment, the twentieth embodiment, and the like and illustrates an example in which the device operation permission region 400 includes a plurality of portions, which enables detection of the predetermined gesture of the operator performed by the touch input. In the illustrated example, a FIG. 4000 including three portions, a first portion 4001, a second portion 4002, and a third portion 4003, is displayed in the device operation permission region 400. In order to detect which portion the touch input has been performed, different coordinates are assigned to each portion on the display screen. The number of portions, a size and a shape of each portion, and the like are not limited to those in this example.

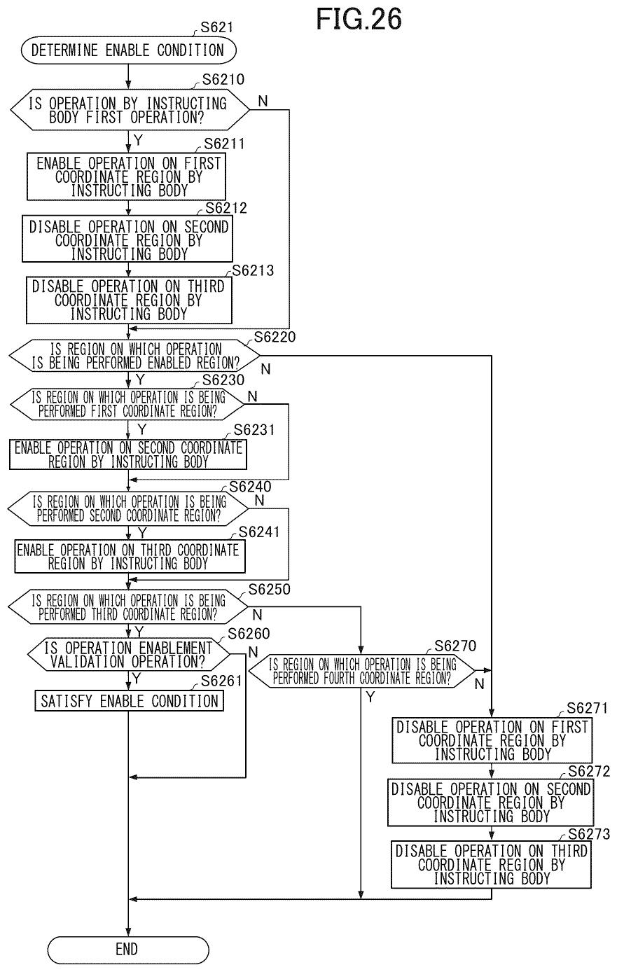

FIG. 26 is a flowchart illustrating details of a procedure performed in enable condition determination processing S621 of FIG. 6 when the touch operation by the contacting body (for example, a finger) is performed on the device operation permission region 400 illustrated in FIG. 25. An example of determining that the enablement is valid in a case where a gesture of touching the first portion 4001, the second portion 4002, and the third portion 4003 in this order with the contacting body is performed is illustrated, but a logic of the enable determination is not limited thereto.

In step S6210, the output control unit 331 determines whether or not the operation on the device operation permission region 400 by the contacting body is the first operation. In a case where the operation on the device operation permission region 400 is the first operation, in steps S6211 to S6213, the output control unit 331 enables the touch operation on the first portion 4001 by the contacting body, and disables the touch operations on the second portion 4002 and the third portion 4003. A region in which the operation is enabled is referred to as an enabled region, and a region in which the operation is disabled is referred to as a disabled region.

Next, in step S6220, the output control unit 331 determines whether or not the region on which the operation by the contacting body is being performed is the enabled region. In a case where the region is the enabled region, in step S6230, the output control unit 331 determines whether or not the region on which the operation by the contacting body is being performed is the first portion 4001. In a case where the region is the first portion 4001, in step S6231, the output control unit 331 enables the operation on the second portion 4002 by the contacting body. In a case where the region is the disabled region, the operation on the first portion 4001, the second portion 4002, and the third portion 4003 by the contacting body is disabled.

Next, in step S6240, the output control unit 331 determines whether or not the region on which the operation by the contacting body is being performed is the second portion 4002. In a case where the region is the second portion 4002, in step S6241, the output control unit 331 enables the operation on the third portion 4003 by the contacting body.

Next, in step S6250, the output control unit 331 determines whether or not the region on which the operation by the contacting body is being performed is the third portion 4003. In a case where the region is the third portion 4003, in step S6260, the output control unit 331 determines whether or not the enable condition is satisfied by the operation on the third portion 4003 by the contacting body. The enable condition may be set such that the operation on the third portion 4003 is any one of a touch operation and a gesture operation.

In a case where the enable condition is satisfied, in step S6261, the output control unit 331 makes the enablement valid. That is, when the contacting body that has started touching from the first portion 4001 performs an operation of passing through the second portion 4002 and reaching the third portion 4003 while maintaining contact, the enable condition is satisfied, and the enablement becomes valid.

In addition, in step S6250, in a case where the region on which the operation by the contacting body is being performed is not the third portion 4003, in step S6270, the output control unit 331 determines whether or not the region on which the operation by the contacting body is being performed is a fourth portion 4004. In a case where the region is not the fourth portion 4004, the operation on the first portion 4001, the second portion 4002, and the third portion 4003 by the contacting body is disabled.

In a case where the region is the fourth portion 4004, the processing ends. In other words, in a case where the operation is performed on the fourth portion 4004, the operation on the first portion 4001, the second portion 4002, and the third portion 4003 by the contacting body is not disabled. Therefore, in a case where the operation is performed on the fourth portion 4004, the enablement and an enabled/disabled state of a coordinate region are not changed at all.

In this way, the device operation permission region 400 includes a plurality of portions, which enables detection of the predetermined gesture of the operator performed by the touch input. Therefore, a possibility of erroneously interpreting the touch operation of the operator is reduced, and an effect of improving the accuracy of the input operation is achieved.

FIGS. 27A and 27B relate to the nineteenth embodiment and the like and illustrate an example in which the device operation permission region 400 includes a plurality of layered portions, which enables detection of the predetermined gesture of the operator performed by touch input. Here, the procedure performed in the enable condition determination processing S621 of FIG. 9 is similar to the flowchart of FIG. 26.

As illustrated in FIG. 27B, in a case where the contacting body operates a display region where the first portion 4001, the second portion 4002, and the third portion 4003 are displayed so as to overlap each other, determination processing for the first portion 4001 is performed in step S6230, determination processing for the second portion 4002 is performed in step S6240, and determination processing for the third portion 4003 is performed in step S6250. By performing the processing in this manner, it is possible to receive the input operation on a region in which the respective coordinate regions are displayed so as to overlap each other.

As the device operation permission region 400 includes a plurality of overlapping portions in this manner, a possibility of erroneously interpreting the touch operation of the operator is reduced, and an effect of improving the accuracy of the input operation is achieved.

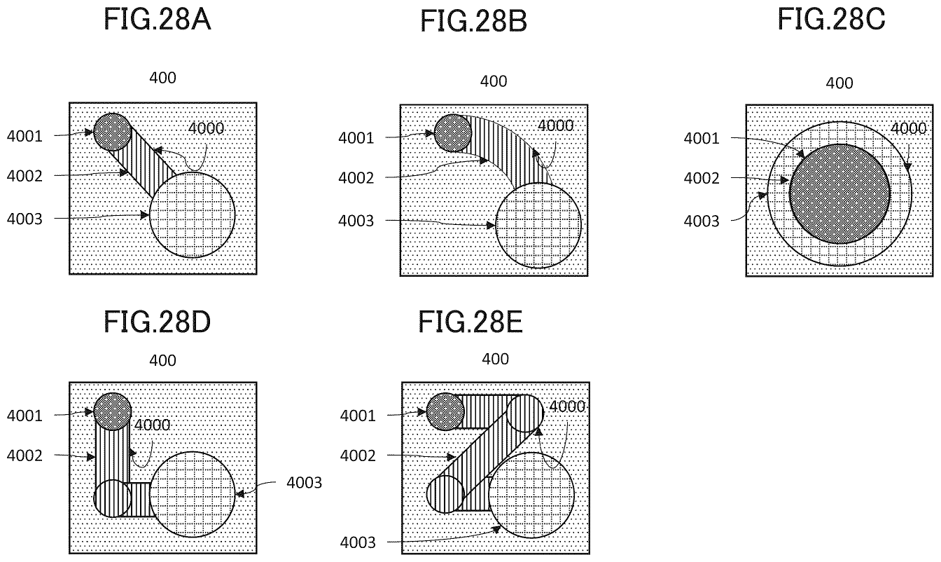

FIGS. 28A to 32 are diagrams illustrating variations of the display form of the device operation permission region 400, which relates to the eighteenth to twentieth embodiments and the like. FIGS. 28A to 28E illustrate an example in which the FIG. 4000 displayed in the device operation permission region 400 includes one first portion 4001.

In the example illustrated in FIG. 28A, the first portion 4001, the second portion 4002, and the third portion 4003 are linearly arranged in the FIG. 4000. In the example illustrated in FIG. 28B, in the FIG. 4000, the second portion 4002 connecting the first portion 4001 and the third portion 4003 has an arc shape. In the example illustrated in FIG. 28C, in the FIG. 4000, the first portion 4001, the second portion 4002, and the third portion 4003 are displayed so as to overlap each other. In the example illustrated in FIGS. 28D and 28E, in the FIG. 4000, the second portion 4002 is displayed in a bent shape.

In step S300 in FIG. 8, the display control unit 324 acquires coordinate region information defining a display form of the FIG. 4000 stored in the screen information 311, and displays the FIG. 4000 in the display region of the device operation permission region 400. The coordinate region information is the shape (a circle, a rectangle, an ellipse, or the like), the size, the display position, a fill color, a border color, the transparency, and the like of each portion forming the FIG. 4000. The operator may edit the coordinate region information in the editing mode. In the coordinate region information, a characteristic shape and arrangement relationship of each portion may be stored as a template image. For example, as for the characteristic shape and arrangement relationship, in the case of the figure in FIG. 28A, the first portion 4001 and the third portion 4003 are circles, the second portion 4002 is a rectangle, and the first portion 4001, the second portion 4002, and the third portion 4003 are arranged on a straight line. Since the operator can display the FIG. 4000 only by designating the template image, the operability is high.

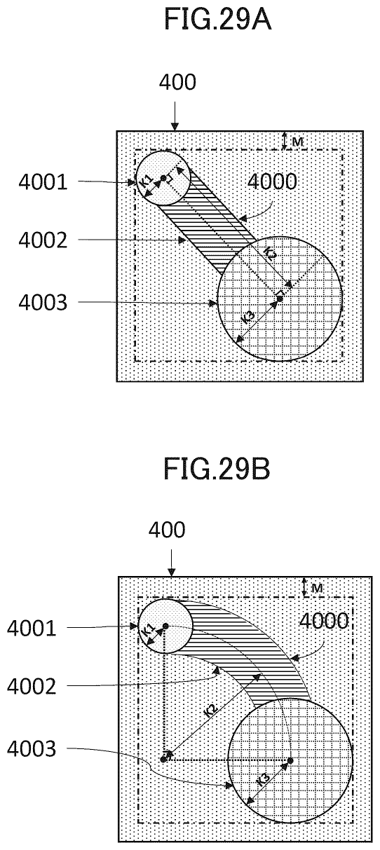

FIGS. 29A and 29B are diagrams illustrating an example in which the operator edits the display form of the device operation permission region 400 by using the template image in the editing stage (editing mode). The operator can edit the shape, size, and display position of the FIG. 4000. The operator first selects the template image. FIG. 29A illustrates a display example in which a template image A is selected, and FIG. 29B illustrates a display example in which a template image B is selected.

Next, the operator edits parameters K1, K2, K3, and M to arbitrary values. The parameter K1 is a radius of the first portion 4001, the parameter K2 is a distance between the first portion 4001 and the third portion 4003, the parameter K3 is a radius of the third portion 4003, and the parameter M is a numerical value indicating a margin. Since the operator can edit the FIG. 4000 by adjusting the parameters and can use the same parameters across different template images, the operability is high.

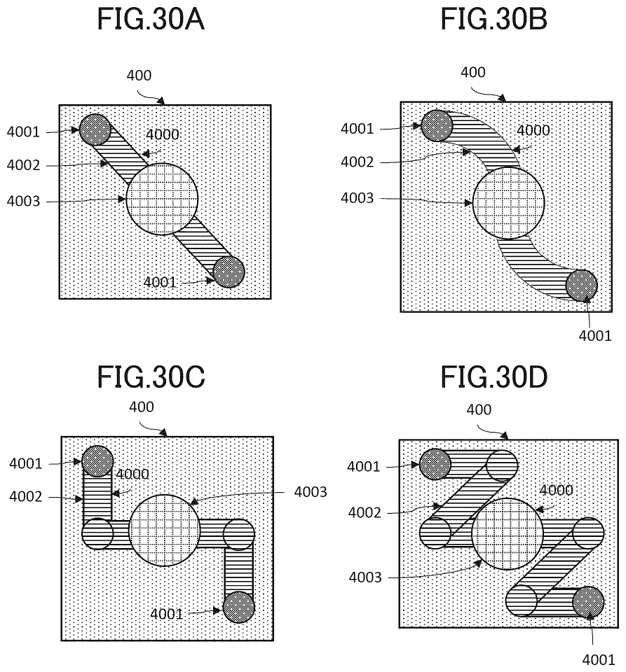

FIGS. 30A to 30D illustrate an example in which the FIG. 4000 displayed in the device operation permission region 400 includes two first portions 4001, which relates to the eighteenth embodiment, the twentieth embodiment, and the like. In a case where only one first portion 4001 is displayed, operability of the touch input may deteriorate depending on a positional relationship between the device operation permission region 400 and the device operation input region 500. Therefore, the FIG. 4000 displayed in the device operation permission region 400 includes a plurality of first portions 4001, thereby improving the operability of the touch input.

For example, in the case of FIG. 28A, in a case where the device operation permission region 400 is displayed on the right side of the device operation input region 500 desired to be operated by the operator, when the device operation permission region 400 is operated with the index finger of the right hand and the device operation input region 500 is operated with the thumb of the right hand, there is no difficulty in operation. However, in a case where the operation is performed with the left hand due to a change in operation posture of the operator or the like, the device operation permission region 400 is operated with the thumb of the left hand, and the device operation input region 500 is operated with the index finger of the left hand. At this time, when the operator tries to perform the operation on the first portion 4001 with the thumb of the left hand, the hand moves such that the device operation input region 500 is hidden by the back of the hand, and thus operability is poor.

On the other hand, by arranging the other first portion 4001 also at a symmetrical position with respect to the third portion 4003 as illustrated in FIG. 30A, the hand moves such that the device operation input region 500 is easily visually recognized, so that the operability is enhanced.

In the editing stage (editing mode), for example, the operator selects the template image from among images illustrated in FIGS. 28A to 28D, and then performs editing such as copying and adding the first portion 4001, thereby generating and displaying the FIG. 4000 as illustrated in FIGS. 30A to 30D.

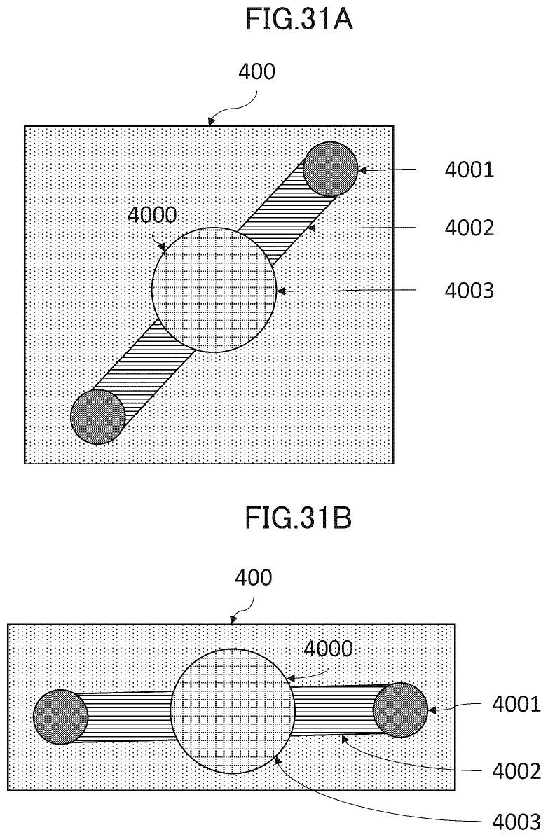

FIG. 31A is a display example in a case where the FIG. 4000 of FIG. 30A displayed in the device operation permission region 400 is horizontally inverted, and FIG. 31B is an example in which the FIG. 4000 is rotated by 45° with the center of gravity of the third portion 4003 as the center of rotation. In addition, the operator may be able to designate an inverting direction in the case of an inverting operation and designate a rotation direction and a rotation amount in the case of a rotation operation. The operator can change the display state such that the figure displayed in the device operation permission region 400 is oriented in a direction in which the touch operation is easy.

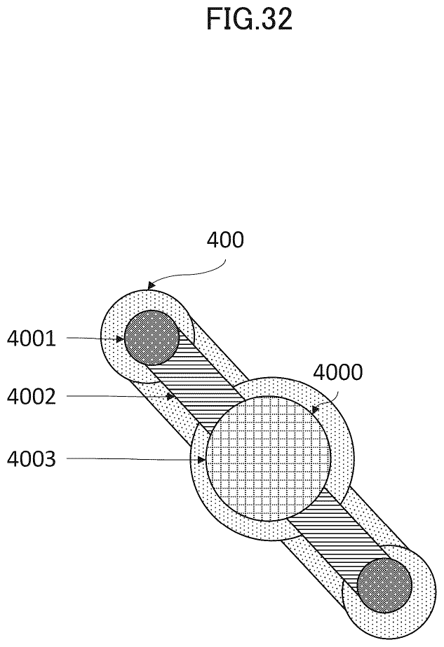

FIG. 32 is a diagram illustrating a display example in a case where the display range of the device operation permission region 400 is reduced when a display range of the FIG. 4000 is very small in the display range of the device operation permission region 400. In a case where the FIG. 4000 illustrated in FIG. 29A is displayed, the display shape of the device operation permission region 400 is changed according to the display shape of the FIG. 4000. Specifically, in a case where the FIG. 4000 is the template image, a display range obtained by enlarging the display range of the FIG. 4000 by the parameter M is set as the display range of the device operation permission region 400. Since a region occupied by the device operation permission region 400 in the control panel image 305 is not excessively large, the display region of the device operation input region 500 can be appropriately secured, and the operability is improved.

FIG. 48 illustrates a case where the device operation permission region 400 includes the FIG. 4000 including the first portion 4001 and the second portion 4002, and the third portion 4003 that does not include the FIG. 4000, which relates to the twenty-second embodiment and the like. As illustrated in FIG. 48, in a case where the contacting body 600 (for example, a finger) moves the touch position with time while touching the third portion 4003, the display position of the device operation permission region 400 is moved so as to follow the movement of the touch position.

The display position of the enable switch (second image) can be easily changed by a gesture with one contact point (for example, one finger). Therefore, the operator can easily change the display position of the enable switch to a position at which the operator can easily perform the touch operation, so that an effect of improving the operability is achieved.

FIGS. 33A to 40B and 46 are diagrams for describing a relationship between a touch aspect (for example, a gesture) by the contacting body and a change in the display state of the device operation permission region 400, which relates to the eighteenth to twenty-fourth embodiments and the like.

FIGS. 33A to 33C illustrate, in time series, a case where the touch position changes in a case where contact is maintained, and a region that is in contact with the contacting body (for example, a finger) is illustrated as a contact surface 601. FIG. 33A illustrates a stage in which the contacting body touches the first portion 4001, FIG. 33B illustrates a stage in which a contact position of the contacting body moves to a display position of the second portion 4002, and FIG. 33C illustrates a stage in which the contact position of the contacting body moves to a display position of the third portion 4003.

In the stage in FIG. 33A, the output control unit 331 determines that the operation is the operation on the first portion 4001 in step S6230 in FIG. 26, and thereafter, enables and receives the touch operation on the second portion 4002 by the contacting body. In the stage in FIG. 33B, the touch operation on the second portion 4002 by the contacting body is enabled as described above. Therefore, in step S6240 in FIG. 26, the output control unit 331 enables and receives the touch operation on the third portion 4003 by the contacting body.

At this time, in step S341, the display control unit 324 may display the first portion 4001 at a center position of the contact surface in conjunction with the movement of the moved contact surface 601, and may display a FIG. 4001′ indicating that the touch operation on the second portion 4002 is enabled separately from the first portion 4001.

In the stage in FIG. 33C, the touch operation on the third portion 4003 by the contacting body is enabled as described above. Therefore, the output control unit 331 determines that the touch input operation has been performed on the third portion 4003 in step S6250 in FIG. 26.

In a case where the touch operation by the contacting body is performed on the third portion 4003, the display control unit 324 may change the display state by changing the color or transparency of the device operation permission region 400 or each portion. In addition, in a case where the operation by the contacting body is performed on the third portion 4003, the display control unit 324 may change the display state by changing the shape or color of the FIG. 4000. In addition, the output control unit 331 may emit a confirmation sound or the like in a case where the operation by the contacting body is performed on the third portion 4003. Since the operator can easily grasp whether or not the touch operation (for example, a gesture) by the contacting body is properly received by the touch panel, the operability is improved.

FIGS. 34A and 34B are diagrams illustrating an example in which the FIG. 4000 displayed in the device operation permission region 400 is changed in a case where the contacting body touches a specific portion (for example, the third portion 4003) of the device operation permission region 400.

FIG. 34A illustrates a stage in which the display control unit 324 displays the FIG. 4000 illustrated in FIG. 28A in the device operation permission region 400, and the contacting body touches the third portion 4003.

In step 6250 in FIG. 26, the output control unit 331 determines that the contacting body has touched the third portion 4003. Then, in step S342 in FIG. 8, the display control unit 324 changes the FIG. 4000 displayed in the device operation permission region 400 to a figure illustrated in FIG. 28C. As a result, the display state of the FIG. 4000 is changed as illustrated in FIG. 34B. Since the FIG. 4000 displayed in the device operation permission region 400 can be changed by a simple touch operation, the operability for the operator is improved.

FIGS. 35A to 36B are diagrams illustrating an example in which the display state of the device operation permission region 400 is changed by a touching gesture using two contacting bodies (for example, fingers), which relates to the twenty-third embodiment and the like. The gesture is, for example, the gesture illustrated in Table 1 of FIG. 46, and the touch operation by two contacting bodies (for example, fingers) is performed within the display range of the device operation permission region 400 and outside the display range of the FIG. 4000. The contact regions of two fingers which are the contacting bodies 600 are illustrated as a contact surface 601 and a contact surface 602. In order to facilitate the gesture, a region outside the FIG. 4000 in the device operation permission region 400 may be enlarged and displayed.

FIGS. 35A and 35B illustrate states before and after the device operation permission region 400 is enlarged or reduced by a gesture of a pinch operation. The display control unit 324 determines that the operation has been performed on the device operation permission region 400 in step S330 in FIG. 8, and changes the display state of the device operation permission region 400 in step S341. In addition, since the gesture is the pinch operation, it is determined that the change in the display state of the device operation permission region 400 is an enlargement or reduction operation, and the display control unit 324 enlarges or reduces the display range of the device operation permission region 400. In a case where the display range of the device operation permission region 400 is enlarged or reduced, the enlargement or reduction operation of the display range of the FIG. 4000 may be performed in conjunction therewith.

In the twenty-fifth embodiment, in order to appropriately determine whether or not the gesture is a predetermined gesture, for example, in a case where the change amounts of the trajectories of the touch positions by two contacting bodies (for example, fingers) are equal to or less than a predetermined distance in a predetermined time, it can be determined that the touches do not correspond to the touch input operation corresponding to the predetermined gesture. Since the display state of the device operation permission region 400 can be changed by a gesture operation performed by a simple touch input, the operability for the operator is improved.

FIGS. 36A and 36B illustrate states before and after the device operation permission region 400 is rotated by a rotation gesture. The display control unit 324 determines that the operation has been performed on the device operation permission region 400 in step S330 in FIG. 8, and changes the display state of the device operation permission region 400 in step S341. Since the gesture is the rotation operation, it is determined that the change in the display state of the device operation permission region 400 is the rotation operation, and the display range of the FIG. 4000 is rotated. Thereafter, the display range of the device operation permission region 400 may be changed to a display range corresponding to the display range of the rotated FIG. 4000.

In the twenty-fifth embodiment, in order to appropriately determine whether or not the gesture is a predetermined gesture, for example, in a case where the change amounts of the trajectories of the touch positions by two contacting bodies (for example, fingers) are equal to or less than a predetermined distance in a predetermined time, it can be determined that the touches do not correspond to the touch input operation corresponding to the predetermined gesture. Since the display state of the device operation permission region 400 can be changed by a gesture operation performed by a simple touch input, the operability for the operator is improved.

FIGS. 37A and 37B illustrate an example in which a display state of a portion of a component of the figure displayed in the device operation permission region 400 is changed by a gesture performed by the touch input, which relates to the twenty-fourth embodiment and the like. The operator can designate the third portion 4003 by touching the third portion 4003 with, for example, two fingers, in the FIG. 4000, and perform an operation of enlarging or reducing only the third portion 4003 by a gesture. Since the operator can easily customize the shape of the FIG. 4000 used for touch operation input to a shape that is easy for the operator to operate, the operability is improved. It is needless to say that the change in the display state is not limited to the illustrated enlargement or reduction of the third portion 4003.

FIGS. 38A and 38B are diagrams illustrating an example in which the display position of the device operation permission region 400 can be moved in the display screen by a gesture performed by the touch input, which relates to the twenty-sixth embodiment and the like. The FIG. 4000 displayed in the device operation permission region 400 includes the first portion 4001 and the second portion 4002. As illustrated in FIG. 38A, it is assumed that the operator touches the second portion 4002 (contact surface 601′) with the contacting body (for example, a finger), and performs a gesture of moving the contacting body to the outside of the FIG. 4000 (illustrated as the contact surface 601) in the device operation permission region 400 while maintaining the contact. Then, as illustrated in FIG. 38B, the display control unit 324 changes the display state so as to move the entire device operation permission region 400 following the movement of the contact surface. The operator can move the display position of the device operation permission region 400 to an easily operable position in the control panel image 305 by a simple touch operation. That is, the display position of the enable switch (second image) can be easily changed without interrupting the input operation on the enable switch (second image), so that an effect of high operability is achieved.

FIGS. 39A and 39B are diagrams illustrating an example in which the display position of the device operation permission region 400 can be moved in the display screen by a gesture performed by the touch input, which relates to the twenty-sixth embodiment and the like. The FIG. 4000 displayed in the device operation permission region 400 includes the first portion 4001 and the second portion 4002.

As illustrated in FIG. 39A, it is assumed that the operator touches the second portion 4002 (contact surface 601′) with the contacting body (for example, a finger), and performs a gesture of moving the contacting body to the first portion 4001 (contact surface 601) of the FIG. 4000 while maintaining the contact. Then, as illustrated in FIG. 39B, the display control unit 324 changes the display state so as to move the entire device operation permission region 400 following the movement of the contact surface. The operator can move the display position of the device operation permission region 400 to an easily operable position in the control panel image 305 by a simple touch operation. That is, the display position of the enable switch (second image) can be easily changed without interrupting the input operation on the enable switch (second image), so that an effect of high operability is achieved.

FIGS. 40A and 40B relate to the twenty-seventh embodiment and the like. In the device operation permission region 400, the first portion 4001 (FIG. 4000) for displaying the information regarding permission of the touch input operation on the device operation input region 500 and the second portion 4002 for receiving the change in the display state of the device operation permission region 400 are displayed. When the touch input detection unit detects the touch on the second portion 4002, the display control unit 324 changes the display state of the device operation permission region 400 according to the detected touch input.

As illustrated in FIG. 40A, it is assumed that the operator touches the second portion 4002 (contact surface 601′) with the contacting body (for example, a finger), and performs a gesture of moving the contacting body to the outside of the device operation permission region 400 while maintaining the contact. Then, the display control unit 324 interprets the gesture as an operation of enlarging or reducing the entire device operation permission region 400, and changes the display state of the entire device operation permission region 400 as illustrated in FIG. 40B. The change in the display state by the touch operation on the second portion 4002 is not limited to enlargement or reduction, and changes of various aspects can be made in association with gestures.

The operator can change the display state of the device operation permission region 400 by a simple touch operation. That is, the display state of the enable switch (second image) can be easily changed without interrupting the input operation on the enable switch (second image), so that an effect of high operability is achieved.

### Deadman Function

Next, the input device according to the embodiment, which has the so-called deadman function, will be described with reference to the drawings. As described above, the deadman function refers to a function of disabling the input in order to prevent the input device from receiving an inappropriate command or the like in a case where an appropriate input operation becomes impossible due to, for example, death or loss of consciousness of the operator, or the operator moves to a position at which the operator cannot operate the input device.

FIG. 41 is a flowchart illustrating a processing procedure in a case where the processing related to the deadman function is executed in the output control processing S60 of FIG. 6 in the input device according to the embodiment, which relates to the twenty-eighth embodiment and the like. The processing from step S610 to step S650 is similar to the processing in the output control processing S60 described with reference to FIG. 9.

In step S651, the output control unit 331 adds the operation command to an operation command list. The operation command list is a list of the operation commands. The operation command list may be stored in the storage unit 310.

Next, in deadman condition determination processing S660, the output control unit 331 executes deadman condition determination processing. The deadman condition is a condition for determining whether or not the operator has fallen into a state such as unconsciousness in the deadman function. In the flowchart of FIG. 41, in the deadman condition determination processing S660, in a case where it is determined that the operator is in a state such as unconsciousness, an affirmation determination (YES) (the deadman condition is satisfied) is made, and in a case where it is determined that the operator can normally perform the input, a negative determination (NO) (the deadman condition is not satisfied) is made.

For example, in a case where contact with the device operation permission region 400 by the contacting body is maintained for a period longer than a predetermined time, it is determined that the deadman condition is not satisfied and the touch input operation on the device operation input region 500 is permitted. An interval for executing the deadman condition determination processing S660 can be set to a time interval sufficient for determining the deadman condition based on a duration of the touch. In addition, the time interval may be settable by the operator.

In a case where the operator touches the enable switch (second image) for a period longer than the predetermined time, the touch is received as a normal touch input operation. However, for example, in a case where the operator cannot maintain contact with the display screen for a period longer than the predetermined time due to loss of consciousness or the like, the input on the enable switch (second image) can be prevented from being received.

In step S670 of the deadman condition determination processing S660, the output control unit 331 determines whether or not the deadman condition is satisfied. In a case where the deadman condition is not satisfied (step S670: NO), the operation command added to the operation command list in step S671 is output.

In a case where the deadman condition is satisfied (step S670: YES), the output control unit 331 invalidates the enablement in step S675, and deletes the operation command added to the operation command list in step S676. Furthermore, at this time, in a case where the FIG. 4000 illustrated in FIG. 25 and the like is used, the touch input operation on the figure may be disabled in step S675. Since it is determined whether or not the operator can perform a normal touch input according to the way of touching the device operation permission region 400, the input operation can be appropriately received, and the accuracy in work is improved.

Next, an example of a deadman condition determination processing method will be described with reference to the drawings of display images displayed on the touch panel. FIGS. 42 to 45 are diagrams illustrating specific examples of the deadman condition determination processing method. In the examples, whether or not the deadman condition is satisfied is determined based on an aspect of the touch input on the FIG. 4000 displayed in the device operation permission region 400.

FIG. 42 relates to the twenty-ninth embodiment and the like, and it is determined that the operator is in a normal state (the deadman condition is not satisfied) in a case where the touch position on the FIG. 4000 by the contacting body remains in a substantially stationary state for a period longer than a predetermined time. That is, in a case where a variation of the touch position of the contacting body in the FIG. 4000 is within a range of a minute distance over a predetermined time, it is determined that the deadman condition is not satisfied, and the touch input operation on the device operation input region 500 is permitted. Such a configuration is based on an empirical rule that the contact position can be maintained in a nearly stationary state for a predetermined time if the operator is in a normal state, and the contact position moves greatly or the contacting body is separated from the display screen if the operator is not in a normal state due to loss of consciousness or the like.

The coordinate acquisition unit 321 acquires coordinate information of the contact surface 601 in the FIG. 4000 every time the main processing is executed. Times at which the coordinates are acquired are time t1, time t2, time t3, time t4, and time t5, and coordinates of the contact surface 601 at each time are coordinates P1, coordinates P2, coordinates P3, coordinates P4, and coordinates P5.

The deadman condition determination processing S660 is executed at time t5, and the output control unit 331 determines whether or not a distance by which the contact surface 601 has moved from time t1 to time t5 is smaller than a predetermined distance. Specifically, the total movement distance obtained by adding a distance between the coordinates P1 and P2, a distance between the coordinates P2 and P3, a distance between the coordinates P3 and P4, and a distance between the coordinates P4 and P5 is defined as the distance by which the contact surface 601 has moved. In a case where the movement distance of the contact surface 601 is less than a predetermined distance, it is determined that the deadman condition is not satisfied. Since it is determined whether or not the operator can perform a normal touch input according to the way of touching the device operation permission region 400, the input operation can be appropriately received, and the accuracy in work is improved.

FIG. 43 relates to the thirtieth embodiment and the like, and it is determined that the operator is in a normal state (the deadman condition is not satisfied) in a case where the touches on the FIG. 4000 displayed in the device operation permission region 400 by a predetermined number of contacting bodies (for example, fingers) are detected simultaneously. Then, the touch input operation on the device operation input region 500 is permitted. Such a configuration is based on an empirical rule that, in a case where the operator is not in a normal state due to loss of consciousness or the like, the operator cannot make a predetermined number of contacting bodies simultaneously touch the FIG. 4000. FIG. 43 illustrates a case where five contact surfaces, the contact surfaces 601 to 605, are simultaneously detected, that is, a case where the predetermined number is five, but the predetermined number is not limited to five. In short, it is sufficient if an aspect of the touch operation that can be consciously performed if the operator is in a normal state, and cannot be performed in a case where the operator is not in a normal state due to loss of consciousness or the like is set.

In the deadman condition determination processing S660 of FIG. 41, the output control unit 331 determines whether or not the number of contacting bodies that come into contact simultaneously is a predetermined number. In a case where the number of contacting bodies is the predetermined number, it is determined that the deadman condition is not satisfied. Since it is determined whether or not the operator can perform a normal touch input according to the way of touching the device operation permission region 400, the input operation can be appropriately received, and the accuracy in work is improved.

FIG. 44 relates to the thirty-first embodiment and the like, and it is determined whether or not the deadman condition set based on a viewpoint different from the twenty-ninth embodiment described with reference to FIG. 42 is satisfied. It is determined that the operator is in a normal state (the deadman condition is not satisfied) in a case where the touch position by the contacting body moves within a range of the FIG. 4000 by a predetermined distance or more within a predetermined time. That is, in a case where the variation of the touch position of the contacting body in the FIG. 4000 is a predetermined distance or more within a predetermined time, it is determined that the deadman condition is not satisfied, and the touch input operation on the device operation input region 500 is permitted. Such a configuration is based on an empirical rule that, in a case where the FIG. 4000 has a limited size, if the operator is in a normal state, it is possible to perform an operation of moving the contact position by a predetermined distance or more within the FIG. 4000 within a predetermined time, and in a case where the operator is not in a normal state due to loss of consciousness or the like, the contact position moves greatly beyond the FIG. 4000 or the contacting body is separated from the display screen.

The coordinate acquisition unit 321 acquires the coordinate information of the contact surface 601 every time the main processing is executed. When the times at which the coordinate information is acquired are time t1, time t2, time t3, time t4, and time t5, coordinates of the contact surface 601 at each time are the coordinates P1, the coordinates P2, the coordinates P3, the coordinates P4, and the coordinates P5.

The deadman condition determination processing S660 of FIG. 41 is executed at time t5, and the output control unit 331 determines whether or not the contact surface 601 is within a range of the FIG. 4000 from time t1 to time t5 and the movement distance is a predetermined distance or more. Specifically, a distance obtained by adding a distance between the coordinates P1 and P2, a distance between the coordinates P2 and P3, a distance between the coordinates P3 and P4, and a distance between the coordinates P4 and P5 is defined as the total distance by which the contact surface 601 has moved. In a case where the total distance of the contact surface 601 is equal to or larger than a predetermined distance, it is determined that the deadman condition is not satisfied. Since it is determined whether or not the operator can perform a normal touch input according to the way of touching the device operation permission region 400, the input operation can be appropriately received, and the accuracy in work is improved.

FIG. 45 relates to the thirty-first embodiment and the like, and it is determined that the operator is in a normal state (the deadman condition is not satisfied) in a case where the trajectory of the touch position on the FIG. 4000 by the contacting body surrounds a predetermined point by a predetermined angle or more. That is, the touch input operation on the device operation input region 500 is permitted. Such a configuration is based on an empirical rule that, in a case where the FIG. 4000 has a limited size, if the operator is in a normal state, it is possible to perform the touch operation of changing the contact position so as to surround a predetermined point within the FIG. 4000 by a predetermined angle or more within a predetermined time, and in a case where the operator is not in a normal state due to loss of consciousness or the like, the touch operation cannot be performed so as to surround the predetermined point by the predetermined angle or more, the contact position protrudes from the FIG. 4000, or the contacting body is separated from the display screen. As described above, in the present embodiment, in a case where the trajectory of the touch position on the enable switch (second image) by the operator surrounds a predetermined point by a predetermined angle or more, the trajectory is received as the operation input.

The coordinate acquisition unit 321 acquires the coordinate information of the contact surface 601 every time the main processing is executed. When the times at which the coordinates are acquired are time t1, time t2, time t3, time t4, and time t5, coordinates of the contact surface 601 at each time are the coordinates P1, the coordinates P2, the coordinates P3, the coordinates P4, and the coordinates P5.

The deadman condition determination processing S660 of FIG. 41 is executed at time t5, and the output control unit 331 calculates a rotation direction of a significant rotation operation and a rotation angle θ about a rotation center point 4500 based on a trajectory of the movement of the contact surface 601 from time t1 to time t5. Specifically, a clockwise rotation is defined as a forward rotation, and a rotation angle θ1 is calculated from a line segment connecting the coordinates P1 and the rotation center point 4500 and a line segment connecting the coordinates P2 and the rotation center point 4500. Similarly, θ2, θ3, and θ4 are calculated by a combination of the coordinate P2 and the coordinate P3, a combination of the coordinate P3 and the coordinate P4, and a combination of the coordinate P4 and the coordinate P5, respectively, and a total rotation angle obtained by summing all the rotation angles is defined as the rotation angle θ. In a case where an absolute value of the rotation angle θ is a predetermined value or more, it is determined that the deadman condition is not satisfied. Since it is determined whether or not the operator can perform a normal touch input according to the way of touching the device operation permission region 400, the input operation can be appropriately received, and the accuracy in work is improved.

FIGS. 49A to 49C relate to the twenty-first embodiment and the like, in which it is detected whether or not the touch on the first portion 4001 and the touch on the second portion 4002 are made by the same contacting body, and it is determined that the touch input operation on the first image is permitted in a case where it is detected that the touches are made by the same contacting body. In the present embodiment, a touch operation by a contacting body other than the finger (contacting body) operating the enable switch (second image) is not received, so that an effect of preventing erroneous input caused by erroneous touch made by, for example, another finger is obtained, and such a configuration is also useful as the deadman function.

For example, it is assumed that the touch input operation on the device operation input region 500 is permitted in a case where the same contacting body sequentially touches the first portion 4001 and the second portion 4002 of the device operation permission region 400. Such a configuration is based on an empirical rule that, if the operator is in a normal state, it is possible to perform such a touch operation with the same contacting body, and in a case where the operator is not in a normal state due to loss of consciousness or the like, it is difficult to perform such an operation with the same contacting body.

As illustrated in FIG. 49A, when the touch on the first portion 4001 by a contacting body 600a (for example, an index finger) is detected, the coordinate acquisition unit 321 continuously tracks the coordinates of the contact surface. By continuously tracking the position of the contact surface, even if the contact position moves as illustrated in FIG. 49B, it can be detected that the contact position corresponds to the contact by the contacting body 600a. Then, in a case where the contacting body 600a moves to the second portion 4002, it is determined that the touch input operation is normal. On the other hand, as illustrated in FIG. 49C, in a case where another contacting body 600b touches the second portion 4002, the position of the contacting body 600a can be tracked, and it can thus be determined that the second portion 4002 is touched by another contacting body. In this case, it is determined that the touch input operation is abnormal, and the touch input operation is not enabled. Since it is determined whether or not the touch operation performed by the operator is normal according to the way of touching the device operation permission region 400, the input operation can be appropriately received, and the accuracy in work is improved.

### Modifications

The present disclosure is not limited to the embodiments described above, and many modifications can be made within the technical idea of the present disclosure. For example, all or some of the different embodiments described above may be combined and implemented.

The input device according to the above-described embodiment can be used as an input device for controlling various devices in addition to the production device. For example, a robot may be used as the production device, and a teaching pendant that outputs an operation command to the robot may be used as the input device. A control method for controlling various devices other than the production device by inputting control information from the input device according to the embodiment also corresponds to the embodiment of the present disclosure. Various devices include, for example, a device capable of performing an operation of extension and contraction, bending and stretching, vertical movement, horizontal movement, or turning, or a combined operation thereof, like a robot, and the robot includes various types such as a vertical articulated type, a parallel-link type, and a linear joint type. The robot may be various service robots in addition to an industrial robot.

Examples of the device operated by connecting the input device according to the embodiment include various production devices used for manufacturing an article. The operation to be performed by the production device using the input device according to the embodiment is typically an operation related to manufacturing of an article, which is represented by assembly of parts, conveyance, machining (including cutting, polishing, drilling, painting, bonding, welding, and the like), and cleaning. The embodiment of the present disclosure also includes an article manufacturing method for manufacturing an article by inputting information related to control of a device used for manufacturing the article from the input device according to the embodiment and controlling an operation of the device.

The present technology can also be implemented by processing in which a program for implementing one or more functions of the embodiments is supplied to a system or a device via a network or a storage medium, and one or more processors in a computer of the system or the device read and execute the program. The present disclosure can also be implemented by a circuit (for example, an ASIC) that implements one or more functions.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-044031, filed Mar. 18, 2025, which is hereby incorporated by reference herein in its entirety.

What is claimed is:

1. An input device comprising:
a display screen; and
a touch input detection unit configured to detect a touch input operation on the display screen, wherein
in a device operation mode in which a device is operable by a user performing the touch input operation on the display screen, a first image and a second image are displayed on the display screen, the first image receiving an operation command for the device by the touch input operation, the second image permitting transmission of the operation command by receiving the touch input operation in a state in which the touch input operation on the first image is performed, and
a display state of the second image is changeable in the device operation mode.

2. The input device according to claim 1, wherein the display state of the second image is changed in a case where the touch input detection unit receives the touch input operation on the second image.

3. The input device according to claim 1, wherein in a case where the touch input detection unit detects the touch input operation on the first image and does not detect the touch input operation on the second image, a display position of the second image is moved so as to approach a position at which the touch input operation is detected in the first image.

4. The input device according to claim 1, wherein in a case where the touch input detection unit detects the touch input operation on the first image including a moving of a touch position with time while touching and does not detect the touch input operation on the second image, a display position of the second image is moved so as to follow the moving of the touch position in the first image.

5. The input device according to claim 1, wherein in a case where the touch input detection unit detects the touch input operation on a position at which the first image is not displayed in a state in which the first image is displayed on the display screen and the second image is not displayed, the second image is displayed at a position at which the touch input operation is detected.

6. The input device according to claim 1, wherein
a reset switch for receiving a command to change the display state of the second image that is being displayed to a predetermined display state set in advance is displayed on the display screen, and
the display state of the second image is changed to the predetermined display state in a case where the touch input detection unit detects the touch input operation on the reset switch.

7. The input device according to claim 1, wherein in a case where a time during which the touch input detection unit detects no touch input operation on either the first image or the second image exceeds a predetermined time, the display state of the second image is changed to a predetermined display state set in advance.

8. The input device according to claim 1, wherein in a state in which the first image and the second image are displayed so as to overlap each other at an arbitrary position on the display screen, in a case where the touch input detection unit detects the touch input operation on the arbitrary position, the touch input operation on the arbitrary position is treated as the touch input operation on the second image.

9. The input device according to claim 1, wherein in a case where the display state of the second image is changed such that the first image and the second image overlap each other at an arbitrary position on the display screen, the first image is moved from the arbitrary position such that the first image and the second image do not overlap each other.

10. The input device according to claim 1, wherein in a case where the display state of the second image is changed such that the first image and the second image overlap each other at an arbitrary position on the display screen, a display position of a portion of the first image other than the arbitrary position is brought close to the arbitrary position.

11. The input device according to claim 1, wherein
the second image includes a first portion and a second portion, and
the touch input detection unit is configured to determine that the touch input operation on the first image is permitted in a case where touches made in a predetermined order on the first portion and the second portion are detected.

12. The input device according to claim 1, wherein
the second image includes a first portion and a second portion displayed on the first portion in an overlapping manner, and
the touch input detection unit is configured to determine that the touch input operation on the first image is permitted in a case where touches made in a predetermined order on the first portion and the second portion are detected.

13. The input device according to claim 11, wherein
the second image further includes a third portion connecting the first portion and the second portion, and
the touch input detection unit is configured to determine that the touch input operation on the first image is permitted in a case where a touch moving from the first portion to the second portion via the third portion is detected.

14. The input device according to claim 1, wherein
in a case where the touch input detection unit simultaneously detects touches by two or more contacting bodies in the second image, it is determined whether or not the touches are the touch input operations corresponding to a predetermined gesture based on trajectories of touch positions by the two or more contacting bodies, and
in a case where it is determined that the touches are the touch input operations corresponding to the predetermined gesture, the display state of the second image is changed to a display state set in association with the predetermined gesture.

15. The input device according to claim 1, wherein
the second image includes a first portion and a second portion,
in a case where the touch input detection unit simultaneously detects touches by two or more contacting bodies in the first portion, the touch input detection unit is configured to determine whether or not the touches are the touch input operations corresponding to a predetermined gesture based on trajectories of touch positions by the two or more contacting bodies, and
in a case where it is determined that the touches are the touch input operations corresponding to the predetermined gesture, a display state of the first portion is changed to a display state set in association with the predetermined gesture.

16. The input device according to claim 1, wherein
the second image includes a first portion and a second portion, and
in a case where the touch input detection unit detects a touching by a contacting body on the second portion and a moving of a touch position by the contacting body, a display position of the second image is moved so as to follow the moving of the touch position.

17. The input device according to claim 1, wherein
the second image includes a first portion for displaying information regarding permission of the touch input operation on the first image, and a second portion for displaying information regarding the display state of the second image, and
in a case where the touch input detection unit detects touch input on the second portion, the display state of the second image is changed according to the detected touch input.

18. The input device according to claim 1, wherein the display state of the second image is changed by enlarging or reducing the second image or changing a display position according to the touch input operation performed by the user.

19. An article manufacturing method using the input device according to claim 1, the article manufacturing method comprising:
inputting information related to control of the device from the input device to the device used for manufacturing an article; and
controlling the device to manufacture the article.

20. A control method for an input device including a display screen, and a touch input detection unit configured to detect a touch input operation on the display screen, the control method comprising:
displaying, in a device operation mode in which a device is operable by a user performing the touch input operation on the display screen, a first image and a second image on the display screen, the first image receiving an operation command for the device by the touch input operation, the second image permitting transmission of the operation command by receiving the touch input operation; and
causing a display state of the second image to be changeable in the device operation mode.

21. A non-transitory computer-readable recording medium in which a program for causing a computer to execute the control method according to claim 20 is stored.
